(19) United States
(12) Patent Application Publication
(10) Pub. No.: US 2019/0233729 A1
(43) Pub. Date: Aug. 1, 2019

(54) LIQUID CRYSTAL COMPOSITE, POLYMER/LIQUID CRYSTAL COMPOSITE MATERIAL, METHOD OF PRODUCING THE SAME, LIQUID CRYSTAL ELEMENT, AND LIQUID CRYSTAL DISPLAY DEVICE

(71) Applicant: SHARP KABUSHIKI KAISHA, Sakai City (JP)

(72) Inventor: YASUHIRO HASEBA, Sakai City (JP)

(21) Appl. No.: 16/257,043

(22) Filed: Jan. 24, 2019

(30) Foreign Application Priority Data
Jan. 26, 2018 (JP) 2018-011555

(51) Int. Cl. C09K 19/32; C09K 19/54

(52) U.S. Cl. CPC C09K 19/322; C09K 2019/546; C09K 2019/323; C09K 19/542

(57) ABSTRACT

A liquid crystal composite according to the technology described herein includes liquid crystal molecules showing liquid crystal properties, a polymerizable monomer polymerized by an external stimulus, the polymerizable monomer having substantially no optical activity, and a chiral compound that is racemized by an external stimulus, the chiral compound having an optical activity.

### CROSS REFERENCE TO RELATED APPLICATION

This application claims priority from Japanese Patent Application No. 2018-011555 filed on Jan. 26, 2018. The entire contents of the priority application are incorporated herein by reference.

### TECHNICAL FIELD

The technology described herein relates to a liquid crystal composite, a polymer/liquid crystal composite material, a method of producing the polymer/liquid crystal composite material, a liquid crystal element, and a liquid crystal display device.

### BACKGROUND

The liquid crystal display device includes a liquid crystal display panel (an example of a liquid crystal element) as a display unit that displays information such as images. The liquid crystal display panel is roughly configured in which a liquid crystal layer is sandwiched between glass substrates. The substrates are each provided with an electrode that applies an electric field to the liquid crystal layer. The control of this electric field changes the orientation of liquid crystal molecules included in the liquid crystal layer to display images on the display unit.

For the liquid crystal molecules in the liquid crystal display panel, nematic liquid crystals that are slender organic molecules are typically used. The nematic liquid crystals are sorted based on dielectric anisotropy into positive liquid crystals having positive dielectric anisotropy and negative liquid crystals having negative dielectric anisotropy. The positive liquid crystals have a dielectric constant large in the major axis direction and small in the direction perpendicular to the major axis. The negative liquid crystals have a dielectric constant small in the major axis direction and large in the direction perpendicular to the major axis.

Liquid crystal molecules typically used in the liquid crystal display panel are thermotropic liquid crystals. In the thermotropic liquid crystals, a liquid crystal phase is exhibited depending mainly only on temperatures. In such liquid crystals, various liquid crystal phases, such as nematic phases and smectic phases, appear based on the difference in degree of order or orientation of molecules. Introducing a chiral compound having optical activities into such a liquid crystal phase causes the force that induces a twist (hereinafter sometimes referred to as helical twist power, HTP), and hence a chiral liquid crystal phase is exhibited.

As an example of the chiral liquid crystal phase, introducing a chiral compound into nematic liquid crystals exhibits a cholesteric (chiral nematic) phase having a helical structure in the molecular orientation. In the cholesteric phase, a so-called Bragg reflection is observed in which light having a specific wavelength (hereinafter sometimes referred to as a selective reflection wavelength) is strongly reflected. The specific wavelength depends on a helical pitch present in the molecular orientation. Applying an electric field to the cholesteric phase exhibiting such Bragg reflection can change or eliminate the selective reflection wavelength.

Enhancing chirality in a liquid crystal component by increasing an amount of a chiral compound added to nematic liquid crystals, for example, sometimes exhibits a blue phase in a narrow-temperature range between the cholesteric phase and the isotropic phase. The blue phase is typically sorted into Blue Phase I, Blue Phase II, and Blue Phase III. Blue Phase I and Blue Phase II are phases in which liquid crystals forming double helical structures present cylinders (double-twisted cylinders) and these cylinders are regularly arranged to form a three-dimensional periodic structure. Blue Phase III is amorphous. The blue phase is an optically isotropic phase. Thus, the blue phase is transparent with application of no electric field, no alignment process is necessary, and viewing angle dependence is low. The blue phase has significantly quick response characteristics in which the response speed to electric fields is significantly quick.

As described above, the chiral liquid crystal phase shows many useful optical properties. However, in the case of cholesteric liquid crystals, in order to easily return molecules to initial molecular orientation after the electric fields are removed, polymer stabilization technologies are known with which a polymer network is formed as a template in a liquid crystal phase. In the blue phase, in order to widen its exhibited temperature range, polymer stabilization technologies are known in which a polymer network is formed in a liquid crystal layer.

Polymer stabilized cholesteric texture (hereinafter sometimes referred to as PSCT) is typically prepared using a liquid crystal composite containing a polymerizable monomer, a nematic liquid crystal molecule, and a chiral compound by polymerization of the polymerizable monomer in a cholesteric phase. In the PSCT, the molecular orientation of liquid crystal molecules is stabilized by a polymer network formed by polymerization of the monomer. However, the PSCT has a high drive voltage, showing a large hysteresis.

An example of such polymer stabilization technologies is disclosed in Nature Materials 1, 64-68 (2002). Nature Materials 1, 64-68 (2002) discloses polymer stabilized blue phases (hereinafter sometimes referred to as PSBP) prepared using a liquid crystal composite containing a polymerizable monomer, a nematic liquid crystal molecule, and a chiral compound by polymerization of the polymerizable monomer in a blue phase. In the PSBP, the presence of the polymer network increases the exhibited temperature range of the blue phase. However, similarly to the PSCT, the PSBP has a high drive voltage, showing a large hysteresis.

An example of such polymer stabilization technologies is disclosed in Adv. Mater., 17, 19, 2311-2315 (2005). Adv. Mater., 17, 19, 2311-2315 (2005) discloses a technology that exhibits a phase referred to as a nanostructured chiral liquid-crystal composite (hereinafter sometimes referred to as NCLC) with which after a liquid crystal component presents an isotropic phase, the polymerization of a monomer is started, a phase transition temperature rises while polymerization, and a polymer network is formed with a blue phase exhibited. The PSBP and the NCLC are all optically isotropic phases.

In a speculation, am increase in a drive voltage in the PSCT and the PSBP might be caused because in these phases, a chiral compound with chirality is present in the liquid crystal component, and this causes a twisting force on liquid crystal molecules. In driving, energy to break the helical structure is necessary against this twisting force. In a speculation, why hysteresis is large is that in the liquid crystal component with chirality, liquid crystal molecules have bistability.

Therefore, in order to solve these problems, technologies that provide PSCT or PSBP liquid crystal components with achirality, namely, a templated nematic phase is proposed. The templated nematic phase includes a polymer network formed by polymerization of the polymerizable monomer in a chiral liquid crystal phase and an achiral liquid crystal component having nematic liquid crystal molecules as a principal component.

It is known that in the case in which the polymer network obtained by polymerization of a chiral monomer is formed in a cholesteric phase, a templated nematic phase is exhibited in which nematic liquid crystal molecules are oriented similarly to liquid crystal molecules in a cholesteric phase due to the presence of a polymer network template. An example of such a templated nematic phase is disclosed in Mat. Res. Soc. Symp. Proc., 425, 293-303 (1996). In Mat. Res. Soc. Symp. Proc., 425, 293-303 (1996), the phase is referred to as a spiral polymer aligned nematic (SPAN), and hence, the templated nematic phase may be hereinafter sometimes referred to as SPAN in the present specification.

When a polymer network is formed in a blue phase, a PSBP is created, and then chiral liquid crystals are removed, a template due to the polymer network is obtained. After a nematic liquid crystal is included in this template, a templated nematic phase is exhibited in which liquid crystal molecules are molecularly oriented similarly to liquid crystal molecules in a blue phase. An example of such a templated nematic phase is disclosed in Applied Physics Letters, 103, 051112 (2013). Applied Physics Letters, 103, 051112 (2013) discloses a technology with which a polymer network template is formed as a liquid crystal component presents a blue phase. In Applied Physics Letters, 103, 051112 (2013), the phase thus exhibited is referred to as a blue-phase polymer templated nematic (BPTN), and the blue-phase polymer templated nematic may be hereinafter sometimes referred to as BPTN in the present specification. Note that, in the method described herein, a phase obtained by a technology below is hereinafter sometimes referred to as BPTN, the phase in which the polymerization of the monomer is started in an isotropic phase, an NCLC is prepared, and the chiral liquid crystal component included in the NCLC is formed into a corresponding achiral liquid crystal component.

With the method disclosed in Mat. Res. Soc. Symp. Proc., 425, 293-303 (1996), ultraviolet rays are applied to a liquid crystal composite made up of nematic liquid crystal molecules, chiral acrylate, a dichroic pigment, an optical initiator at a temperature at which a cholesteric phase is presented. Thus, the SPAN of a polymer/liquid crystal composite material made up of a polymer-network and an achiral liquid crystal component mainly formed of nematic liquid crystal molecules is prepared. With this method, most of chiral acrylate having chirality is polymerized and incorporated into the polymer network. After the polymer network is formed, the chirality of the liquid crystal component is reduced to be substantially an achiral liquid crystal component.

However, the helical pitch in the cholesteric phase depends on the twisting force due to the chirality of the liquid crystal component, i.e., the HTP or concentration of the chiral compound present in the liquid crystal component. Thus, the helical pitch in the cholesteric phase is elongated as polymerization proceeds and chiral acrylate in the liquid crystal component is reduced. The molecular alignment of the polymer network formed in this cholesteric phase is then changed, variations occur in the helical pitch of the molecular orientation of liquid crystal molecules arranged as the polymer network is the template in the SPAN, and the distribution becomes broad. As a result, in the SPAN prepared by the method disclosed in Nature Materials 1, 64-68 (2002), although the drive voltage is reduced, the reflected wavelength becomes broad to reduce the reflectance at the selective reflection wavelength before polymerization. Thus, the SPAN is not suitable for applications in which a high reflectance is desired at a specific selective reflection wavelength, for example.

On the other hand, with the method disclosed in Adv. Mater., 17, 19, 2311-2315 (2005), ultraviolet rays are first applied to a liquid crystal composite made up of a nematic liquid crystal molecules, a chiral compound, a polymerizable monomer, and an optical initiator at a temperature at which a blue phase is presented, and a polymer network is formed in a blue phase. Subsequently, unpolymerized components after the polymer network is formed are cleaned with a solvent and dried. Lastly, nematic liquid crystal molecules are injected, and then the BPTN of a polymer/liquid crystal composite material made up of a polymer network template formed in a blue phase and an achiral liquid crystal component mainly formed of nematic liquid crystal molecules is prepared. The BPTN thus prepared shows a low drive voltage and a small hysteresis. However, the producing process of the BPTN is complicated, and producing the BPTN is highly difficult, as described above.

### SUMMARY

The technology described herein was made in view of the above circumstances. An object is to provide a polymer/liquid crystal composite material that can exhibit a templated liquid crystal phase showing useful optical properties by a simple method. The technology described herein provides a liquid crystal composite that obtains the polymer/liquid crystal composite material, a liquid crystal optical modulation element using the polymer/liquid crystal composite material, and a liquid crystal display device.

A liquid crystal composite according to the technology described herein includes: liquid crystal molecules showing liquid crystal properties; a polymerizable monomer polymerized by an external stimulus, the polymerizable monomer having substantially no optical activity; and a chiral compound that is racemized by an external stimulus, the chiral compound having an optical activity.

In the present specification, the term “having substantially no optical activity” means that the polymerizable monomer has no optical activity at all or has a small HTP to the degree that does not interfere with exerting the effect of the technology described herein although the monomer has an optical activity. For example, as described below, a polymerizable monomer having substantially no optical activity is monomers in which polymerized polymers are removed from the liquid crystal composite including the un-polymerized polymerizable monomer, the chirality of the remaining liquid crystal component is maintained at nearly constant before the polymerization of the monomer is started until polymerization is completed.

In the present specification, the polymer formed by polymerization of the polymerizable monomer as the liquid crystal composite in the configuration is a starter is sometimes referred to as a “polymer network”. The component that is the remaining component of the liquid crystal composite from which the polymer network is removed is sometimes referred to as a “liquid crystal component”. In the process of forming the polymer network, the liquid crystal component at least includes liquid crystal molecules, a chiral compound, and an unreached polymerizable monomer. In the technology described herein, with the polymerization of the polymerizable monomer and the racemization of the chiral compound included in the liquid crystal composite, the polymer/liquid crystal composite material formed of the polymer network and the achiral crystal component including the racemate of the chiral compound and the liquid crystal molecules is obtained.

In the present specification, the term “achiral liquid crystal component” is not limited to ones having no optical activity at all. Components having an optical activity to the degree that twisting force acting on the liquid crystal molecules included in the liquid crystal component is sufficiently small and the liquid crystal molecular orientation can be easily changed are also included in the scope of the technology described herein. Similarly, in the present specification, the term “racemate” is not necessarily limited to a perfect equal part mixture of the enantiomer. Even though one of the enantiomers is resent in larger quantity than that of the other, the liquid crystal component including the racemate is achiral in the description above.

The liquid crystal composite in the configuration includes the liquid crystal molecules and the chiral compound, and hence the composite can exhibit the chiral liquid crystal phase. Upon imparting an external stimulus to polymerize the polymerizable monomer with a predetermined chiral liquid crystal phase presented in the liquid crystal composite, a polymer network having the chiral liquid crystal phase as a template is formed. The polymer network thus obtained can molecularly orient the liquid crystal molecules included in the liquid crystal component similar to the liquid crystal molecules in the predetermined chiral liquid crystal phase.

Note that in the configuration, the polymerizable monomer may include at least one kind of polymerizable monomer having mesogen, for example, and showing liquid crystal properties. This configuration avoid an excessive decrease in the upper limit of the temperature of the chiral liquid crystal phase before the polymer network is formed (phase transition temperature between the liquid crystal phase and the isotropic phase that is sometimes referred to as transparent point). Alternatively, in the configuration, for the chiral compound, chiral compounds may be used which have mesogen, show liquid crystal properties, have an optical activity, and are racemized with an external stimulus.

According to the configuration, the polymerizable monomer that contributes to forming the polymer network has substantially no optical activity. Thus, the chirality of the liquid crystal component is hardly decreased even though the formation of the polymer network is advanced, and the chirality of the liquid crystal component can be maintained at nearly constant before the start of the polymerization of the polymerizable monomer until the formation of the polymer network is completed. Specifically, preferably, the liquid crystal component maintains a chirality of 80% or more before polymerization is started after the polymer network is formed, and a chirality of 90% or more is more preferable. Thus, during formation of the polymer network, the structure of the chiral liquid crystal phase can be maintained at nearly constant. Therefore, the polymer network excellently reflects the structure of the chiral liquid crystal phase exhibited by the liquid crystal composite before the polymerization of the polymerizable monomer. The polymer/liquid crystal composite material thus obtained can exhibit a phase showing useful optical properties similar to the chiral liquid crystal phase before monomer polymerization. For example, in the cholesteric phase in which liquid crystal molecules are molecularly oriented using this polymer network as a template, Bragg reflection at the selective reflection wavelength before the start of the monomer polymerization is maintained. Note that the liquid crystal composite according to the technology described herein may include a chiral polymerizable monomer having an optical activity in addition to polymerizable monomers with substantially no optical activity. The chiral polymerizable monomer is used in a part of the polymerizable monomer that contributes to forming the polymer-network. Thus, for example, the selective reflection wavelength in the cholesteric phase in which the liquid crystal molecules are molecularly oriented using the polymer network as a template can be intentionally widened, and the wavelength can be controlled in a desired range.

According to the configuration, the chiral compound that imparts chirality to the liquid crystal component is racemized due to an external stimulus. Thus, imparting an external stimulus to the liquid crystal component can decrease the chirality of the liquid crystal component, and an achiral component can be formed. Thus, twisting force acting on the liquid crystal molecules is reduced, and the drive voltage is reduced.

In the configuration, from the viewpoint of suppressing a decrease in the upper limit of the temperature of the chiral liquid crystal phase, for example, the chiral compound is preferably chiral compounds that have a large HTP and can Induce a desired helical pitch with addition of a small amount. In order to prepare a homogeneous liquid crystal composite, the chiral compound is preferably excellent in compatibility with liquid crystal molecules.

In the configuration, the external stimulus that induces the polymerization of the monomer and the external stimulus that induces the racemization of the chiral compound may be the same or different type of stimulus. However, under the conditions in which an external stimulus that induce the polymerization of the monomer is imparted, the racemization velocity of the chiral compound is preferably slower than the polymerization velocity of a polymerizable monomer. With this configuration, an external stimulus that polymerizes the monomer is imparted to the liquid crystal composite, hence the monomer is polymerized prior to the racemization of the chiral compound, and the formation of the polymer-network cam be completed before the chirality of the liquid crystal component is greatly changed due to racemization.

Specifically, as the external stimulus, the application of heat or light, for example, can be thought. However, for example, the external stimulus that induces the polymerization of the monomer and the external stimulus that induces the racemization of the chiral compound can be the application of light. This configuration is preferable, from the viewpoint of the polymerization reaction velocity of the polymerizable monomer, the racemization time of the chiral compound, and heat resistance of other members, for example, and from the viewpoint of simplifying a method of producing the polymer/liquid crystal composite material, described later. In this case, the wavelength of light suitable for inducing the polymerization of the monomer and the wavelength of light suitable for inducing racemization may be the same or different.

Imparting the external stimulus that induces the polymerization of the monomer and imparting the external stimulus that induces the racemization of the chiral compound may be simultaneously started. For example, in the case in which these external stimuli are light at the same wavelength, the application of the light to the liquid crystal composite simultaneously starts the polymerization of the monomer and the racemization of the chiral compound. In this process, as described above, the racemization velocity of the chiral compound under the application of the light is adjusted such that the racemization velocity is sufficiently smaller than the polymerization velocity of the monomer, and the racemization of the chiral compound is completed after the polymerization of the monomer is completed. The polymerization of the monomer prior to the racemization of the chiral compound enables the completion of the formation of the polymer network before the chirality of the liquid crystal component is changed. With this configuration, the continuous application of light at a specific wavelength enables the polymerization of the monomer and the racemization of the chiral compound, which is preferable from the viewpoint of simplifying a method of producing the polymer/liquid crystal composite material.

As described above, with the use of the liquid crystal composite, by a simple method with which an external stimulus is given to the liquid crystal composite, the liquid crystal phase showing useful optical properties unique to the chiral liquid crystal phase with a low drive voltage and a low hysteresis can be stably exhibited in a wide temperature range.

A polymer/liquid crystal composite material according to the technology described herein includes an achiral liquid crystal component and a polymer network. The achiral liquid crystal component includes liquid crystal molecules showing liquid crystal properties, and a racemate of chiral compound. The polymer network molecularly orients the liquid crystal molecules similarly to liquid crystal molecules in a predetermined chiral liquid crystal phase.

According to the configuration, the liquid crystal molecules are molecularly oriented similarly to the liquid crystal molecules In the chiral liquid crystal phase by the polymer network, and hence useful optical properties unique to the chiral liquid crystal phase is obtained. The liquid crystal component is an achiral liquid crystal component, and hence a low drive voltage and a low hysteresis are achieved. The polymer/liquid crystal composite material that can exhibit such a phase can be prepared by the method with which the chiral compound that has contributed to exhibiting a chiral liquid crystal phase is racemized by imparting an external stimulus. The inclusion of the racemate of the chiral compound thus generated in the liquid crystal component is a characteristic.

A method of producing a polymer/liquid crystal composite material according to the technology described herein includes: preparing a liquid crystal composite including liquid crystal molecules showing liquid crystal properties, a polymerizable monomer having substantially no optical activity and polymerized by an external stimulus, and a chiral compound having an optical activity and racemized by an external stimulus; forming a polymer network by imparting an external stimulus to polymerize the polymerizable monomer with a predetermined chiral liquid crystal phase presented in the liquid crystal composite; and racemizing to impart an external stimulus such that racemization of the chiral compound is completed after completion of polymerization of the polymerizable monomer. Here, the polymer-network molecularly orients the liquid crystal molecules included in a liquid crystal component from which the polymer network is removed from the liquid crystal composite similarly to liquid crystal molecules in the predetermined chiral liquid crystal phase, and the external stimulus that induces polymerization of the polymerizable monomer is selected such that under conditions in which the external stimulus is imparted, the polymerization velocity of the polymerizable monomer is faster than racemization velocity of the chiral compound, and chirality of the liquid crystal component is maintained at nearly constant before start of polymerization of the polymerizable monomer until formation of the polymer network is completed.

According to the configuration, the polymerizable monomer is polymerized prior to the racemization of the chiral compound, and a polymer network is formed with the chirality of the liquid crystal component kept at nearly constant. Thus, the polymer network can be formed in which the structure of the chiral liquid crystal phase before the polymerization of the monomer is excellently reflected. The chiral compound is then racemized to form the liquid crystal component into an achiral liquid crystal component. As described above, by a significantly simple method with which an external stimulus is imparted to the liquid crystal composite, a polymer/liquid crystal composite material that can exhibit useful optical properties unique to the chiral liquid crystal phase with a low drive voltage and a low hysteresis the liquid crystal phase is obtained.

In the present specification, the term “liquid crystal element” is an element that exerts functions in which the application of an electric field, for example, changes the molecular orientation of liquid crystal molecules into an orientation different from the initial state, a change in the optical properties of the liquid crystal the is produced due to a change in the orientation is used, and then the incident light is caused to scatter, interfere, reflect, or pass, or the element that changes the degrees of the operation. The “liquid crystal element” includes elements, such as liquid crystal display elements, liquid crystal optical modulation elements, and switching elements.

According to the configuration, a liquid crystal element that shows useful optical properties unique to the chiral liquid crystal phase with a low drive voltage and a low hysteresis can be provided. For example, a typical liquid crystal display element, such as a liquid crystal display panel, can be provided in which the alignment of the liquid crystal molecules is controlled by application of an electric field to the liquid crystal layer through the electrode, the birefringence of light is changed to display images. Alternatively, for example, the technology described herein is useful for a liquid crystal lens in which the application of an electric field to the liquid crystal layer through the electrode changes the refractive index and hence the focal length is controlled, or a liquid crystal optical element for a waveguide, for example.

According to the configuration, a typical liquid crystal display device as well as a liquid crystal display device having various characteristics can be provided, utilizing the properties of the polymer/liquid crystal composite material according to the technology described herein.

According to the technology described herein, a liquid crystal element that shows useful optical properties unique to the chiral liquid crystal phase, such as quick response characteristics, a wide viewing angle, and Bragg reflection at a selective reflection wavelength, has a wide drive temperature range with a low drive voltage and a low hysteresis cam be provided by a simple method.

### BRIEF DESCRIPTION OF THE DRAWINGS

FIGS. 1A to 1C are schematic diagrams of images of molecular orientation states of a polymer/liquid crystal composite material in Blue Phase I, illustrating double-twisted cylinders in FIG. 1A, the stacked state of double -twisted cylinders in FIG. 1B, and disclination lines in FIG. 1C.

FIG. 2 is a schematic diagram of distribution images of a polymer network in a BPTN according to the first embodiment.

FIGS. 3A and 3B are schematic diagrams of images of birefringence change in a liquid crystal layer of a liquid crystal display device according to a first embodiment-1, the birefringence change being formed of the BPTN prepared in the first embodiment, illustrating the image before electric field application in FIG. 3A and the image after electric field application in FIG. 3B.

FIG. 4 is a schematic diagram, of the schematic structure of a liquid crystal lens according to a first embodiment-2.

FIGS. 5A and 5B are schematic diagrams of images of changes in the focal point of a liquid crystal lens, illustrating the image before electric field application in FIG. 5A and the image after electric field application in FIG. 5B.

FIGS. 6A and 6B are schematic diagrams of images of liquid crystal molecular orientation states of a polymer/liquid crystal composite material that exhibits a SPAN according to a second embodiment, illustrating the image before racemization in. FIG. 6A and the image after racemization in FIG. 6B.

FIGS. 7A and 7B are schematic diagrams of images of liquid crystal molecular orientation states of a liquid crystal layer of a liquid crystal cell according to a second embodiment-1, the liquid crystal layer being formed of the SPAN prepared in the second embodiment, illustrating the image before electric field application in FIG. 7A and the image after electric field application in FIG. 7B.

FIGS. 8A and 8B are schematic diagrams of images of the liquid crystal molecular orientation states of a liquid crystal layer of a liquid crystal cell according to a second embodiment-2, the liquid crystal layer being formed of the SPAN prepared in the second embodiment, illustrating the image before electric field application in FIG. 8A and the image after electric field application in FIG. 8B.

FIG. 9 is a schematic diagram of the schematic configuration of a liquid crystal display device according to a second embodiment-3 having the liquid crystal layer formed of the SPAN prepared in the second embodiment.

FIGS. 10A and 10B are schematic diagrams of images of the liquid crystal molecular orientation states of a liquid crystal layer of a liquid crystal display device according to a second embodiment-4, the liquid crystal layer being formed of the SPAN prepared in the second embodiment, illustrating the image before electric field application in FIG. 10A and the image after electric field application in FIG. 10B.

FIGS. 11A and 11B are schematic diagrams of images of the liquid crystal molecular orientation states of a liquid crystal layer of a light modulation element according to a second embodiment-5, the liquid crystal layer being formed of the SPAN prepared in the second embodiment, illustrating the image before electric field application in FIG. 11A and the image after electric field application in FIG. 11B.

### DETAILED DESCRIPTION

### First Embodiment: A Polymer/Liquid Crystal Composite Material that Exhibits a BPTN

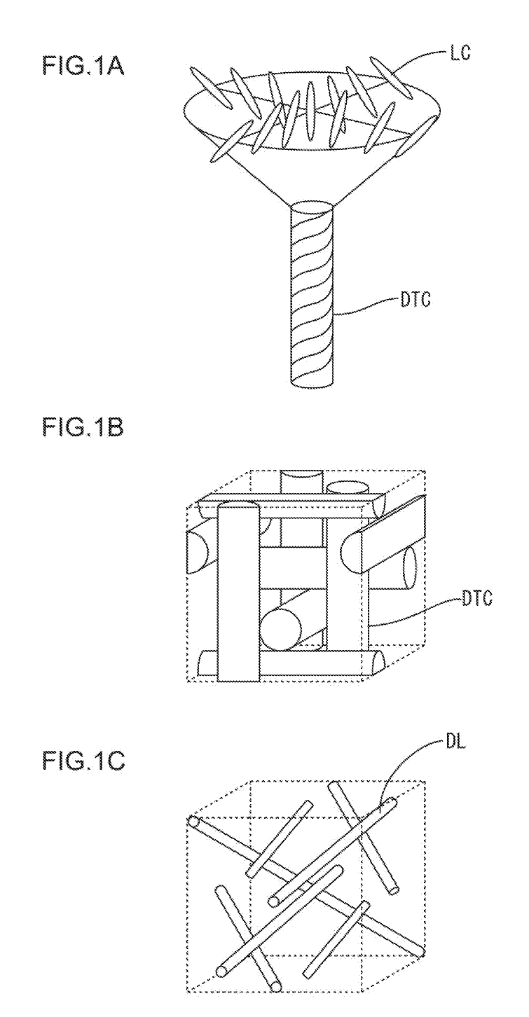

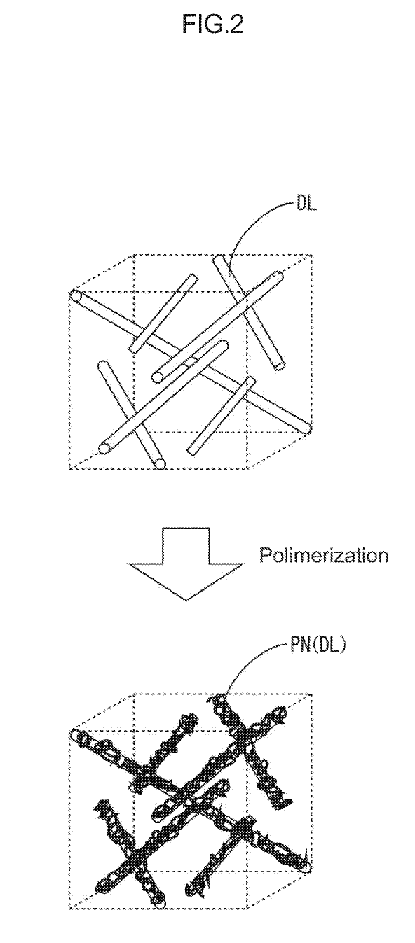

Referring to FIGS. 1A to 1C and FIG. 2, a first embodiment will be described. In the first embodiment, an example of a polymer/liquid crystal composite material that can exhibit a so-called BPTN is shown.

BPTN

In the present specification, the term “BPTN” is a phase includes a polymer network PN and an achiral liquid crystal component, and is the phase exhibited in which liquid crystal molecules LC in the achiral liquid crystal component are arranged similarly to liquid crystal molecules LC in a blue phase using the polymer network PN as a template. The BPTN microscopically has a liquid crystal order similarly to the blue phase, but the BPTN is macroscopically an optically isotropic phase in which liquid crystal molecules LC are isotropically molecularly oriented. FIGS. 1A to 1C are schematic diagrams of a blue phase (Blue Phase I in detail). In Blue Phase I, a double twist cylinder DTC is made up of liquid crystal molecules LC in double twisted molecular orientation as illustrated in FIG. 1A, the double -twisted cylinders are stacked as illustrated in FIG. 1B, and the double-twisted cylinders DTC and disclination lines DL as illustrated in FIG. 1C coexist. When a PSBP is prepared by forming a polymer network PN in such a phase, it is thought that the formed polymer network PN is concentrated disclination lines as illustrated in FIG. 2.

In the first embodiment, after a PSBP made up of a polymer network and a chiral liquid crystal component is prepared, the chiral compound in the liquid crystal component is racemized to make the liquid crystal component achiral, and then a BPTN is prepared.

Liquid Crystal Composite

The polymer/liquid crystal composite material according to the technology described herein can be prepared using a liquid crystal composite including liquid crystal molecules showing liquid crystal properties, a polymerizable monomer having substantially no optical activity and polymerized by an external stimulus, and a chiral compound having an optical activity and racemized by an external stimulus. In the following, the components will be described.

Polymerizable Monomer Polymerized by an External Stimulus

The polymerizable monomer used in the technology described herein has a function in which a liquid crystal component including the polymerizable monomer that is unreacted is polymerized, with a predetermined chiral liquid crystal phase presented, to form a polymer network, and hence the exhibited temperature range of the chiral liquid crystal phase for stabilization. Note that the term, “polymerizable monomer” used in the technology described herein includes not only low-molecular weight monomers as well as macro monomers, oligomers, and any other components. In the technology described herein, from the viewpoint of suppressing a change in the chirality of the liquid crystal component in forming the polymer network, components with no optical activity are preferably used for the polymerizable monomer. Examples of polymerizable monomers with no optical activity that can be used include monomers with no optical activity at all as well as monomers with a small HTP to the degree that does not interfere with exerting the effect of the technology described herein.

The liquid crystal composite according to the technology described herein includes, as a polymerizable monomer, one kind or two kinds or more of polymerizable monomers polymerized by an external stimulus. For the polymerizable monomer according to the first embodiment, an appropriate one can be selected from publicly known polymerizable monomers used for the PSBP or the NCLC and used alone or in the combination of two kinds or more.

From the viewpoint of suppressing a decrease in the upper limit of the temperature of the chiral liquid crystal phase due to the addition of the polymerizable monomer used in the technology described herein, at least one kind of the polymerizable monomer preferably has mesogen. In the first embodiment, an example of using mesogen is shown as a polymerizable monomer. The polymer network formed by polymerization preferably has a three-dimensional cross-linked structure. From such a viewpoint, at least one kind of polymerizable monomer is preferably a polyfunctional monomer.

As the external stimulus that induces the polymerization of the polymerizable monomer, the application of heat or light, for example, can be thought. However, from the viewpoint of the reaction velocity and the reliability, the external stimulus is preferably the application of light. The polymerizable monomer may be a self-cleavage monomer that is self-cleaved by an external stimulus to start polymerization. Alternatively, as described later, the polymerization of the polymerizable monomer may be started in combination with a light cleavage or heat cleavage polymerization initiator, for example. The polymerization reaction mechanism of the polymerizable monomer is non-limiting. The polymerizable monomer can be polymerized by given reactions, such as radical polymerization and cationic polymerization. In order to advance the polymerization of the polymerizable monomer faster than the racemization reaction of the chiral compound, described later, a polymerizable monomer having a fast polymerization velocity is preferably used. The types of functional groups for the polymerization of the polymerizable monomer are non-limiting. Polymerizable monomers having an acrylic group, methacryl group, glycidyl group, epoxy group, and a vinyl group, for example, can be used. From the viewpoint of polymerization velocity, polymerizable monomers including an acrylate group or a methacrylate group are preferable.

In the first embodiment, an example is shown in the case in which a photopolymerizable monomer having mesogen is used and a photoracemized chiral compound,, described later, is also used for the chiral compound. In this case, as the external stimulus that induces the polymerization of the polymerizable monomer, light having a wavelength preferably selected at which the polymerization velocity of the monomer is faster than racemization velocity of the chiral compound under the application of the light. In order to advance the photopolymerization of the polymerizable monomer faster than the photoracemization velocity of the chiral compound by the application of light that induces the polymerization of the monomer, or in order to increase the difference in the velocity between these reactions, a useful method is a method with which the wavelength of light that induces the polymerization of the monomer is shifted from the wavelength of light that induces the racemization of the chiral compound to the long wavelength side or the short wavelength side. For example, it is considered to select a polymerizable monomer that starts polymerization using light at a wavelength longer than the light necessary to the photoracemization of the chiral compound or to select a polymerization initiator as necessary.

Chiral Compound that is Racemized by an External Stimulus

The chiral compound used in the technology described herein has a function that imparts chirality to the liquid crystal component, applies twisting force to liquid crystal molecules, and hence contributes to exhibiting a chiral liquid crystal phase until the formation of the polymer network is completed. In the polymer/liquid crystal composite material after the polymer network is formed, the chiral compound is included as the compound is in a racemized state in the achiral liquid crystal component.

In the technology described herein, from, the viewpoint of suppressing a decrease in the upper limit of the temperature of the chiral liquid crystal phase, for example, a chiral compound having a large HTP is preferably used. The chiral compound can induce a desired helical pitch with addition of a small amount. In order to prepare a homogeneous liquid crystal composite, the chiral compound is preferably excellent in compatibility with liquid crystal molecules.

The liquid crystal composite according to the technology described herein includes one kind or two kinds or more of chiral compounds that are racemized by an external stimulus. For such a chiral compound, ones publicly known as chiral compounds that are racemized by an external stimulus, such as light or heat, can be used, and an appropriate one is selected from compounds having a substituent group introduced into the publicly known chiral compound, and used alone or in the combination of two kinds or more.

As the external stimulus that induces the racemization of the chiral compound, the application of heat or light, for example, can be thought. However, from the viewpoint of racemization time and heat resistance of other members, the external stimulus that induces racemization is preferably the application of light. The mechanism of photoracemization is non-limiting. The chiral compounds that are racemized by photoisomerization, optical inversion, and a photocyclization reaction, for example, can be used. The chiral compounds that are racemized by Light stimulus are under investigation in various fields. Examples of such chiral compounds can include a chiral compound having a binaphthyl skeleton described in Journal of Physical Chemistry, 96 (7), 3063-3067 (1992), a chiral compound having a biphenyl skeleton described in Chemical Physics Letters, 38 (3), 456-459 (1976), and an aromatic sulfoxide chiral compound described in Chem. Lett. 199, 87-88 (1999).

Among them, a photoracemized chiral compound having a binaphthyl skeleton in the molecule, and a photoracemized binaphthyl derivative that is altered by substituent group introduction, or atom, substitution, for example, to the degree that its structure or properties are not greatly changed can be specifically preferably used. Among them, photoracemized chiral compounds expressed by chemical formula (1) can be specifically preferably used. These chiral compounds have a large HTP, have excellent compatibility with nematic liquid crystal molecules typically used, and have a slow racemization velocity.

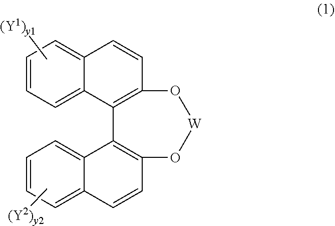

In chemical formula (1), W is a bivalent alkylene group having one to four carbon (C) atoms. W may be substituted by X. In chemical formula (1), X, Y¹, and Y² are independent from each other, and are straight-chain or branched alkyl having F, Cl, Br, I, CN, SCN, SF₅, and one to 25 C atoms, or cycloalkyl or aryl having up to 20 C atom, or mesogen M, and y1 and y2 are independent from each other, and are 0, 1, 2, 3, or 4.

The straight-chain or branched alkyl having one to 25 C atoms may be monosubstituted or multisubstituted by F, Cl, Br, I, or CN, and additionally here, one or two or more of non-neighboring CH₂ groups maybe independently substituted by —O—, —S—, —NH—, NR⁰—, —CO—, —COO—, —OCO—, —OCOO—, —S—CO—, —CO—S—, —CH═CH—, or —C≡C— such that O and/or S atoms are not directly bonded to each other, and R⁰ is alkyl having H or one to four C atoms.

The cycloalkyl or aryl having up to 20 C atoms may be monosubstituted or multisubstituted by optionally halogen, preferably F, or a polymerizable group.

The mesogen M is expressed by —Z¹-A¹-(Z²-A²)m-R or alternatively by R¹ or A³.

Z¹ and Z² are independent from each other, and are a single bond, —O—, —S—, —CO—, —COO—, —OCO—, —O—COO—, —CO—NR⁰—, —NR⁰—CO—, —O—CH₂—, —CH₂—O—, —S—CH₂—, —CH₂—S—, —CF₂—O—, —O—CF₂—, —CF₂—S—, —S—CF₂—, —CH₂—CH₂—, —CF₂—CH₂—, —CH₂—CF₂—, —CF₂—CF₂—, —CH═N—, —N═CH—, —N═N—, —CH═CH—, —CF═CH—, —CH═CF—, —CF═CF—, —C≡C—, or the combination of two groups where two of O and/or S and/or N atoms are not directly bonded to each other. Z¹ and Z² are preferably a single bond, —COO—, —OCO—, —CF₂—O—, —O—CF₂—, —CH═CH—COO—, or —OCO—CH═CH—.

A¹, A², and A³ are independent from each other, and are 1,4-phenylene where one or two non-neighboring CH groups may be substituted by N, 1,4-cyclohexylene where one or two non-neighboring CH₂ groups may be substituted by O and/or S, 1,3-dioxolane-4,5-diyl, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl. Here, each of the groups may be monosubstituted or multisubstituted by L, and A¹ is a single bond.

L is a halogen atom, preferably F, CN, NO₂, or alkyl, alkoxy, alkylcarbonyl, alkoxycarbonyl, or alkoxycarbonyloxy having one to seven C atoms. Here, one or two or more of H atoms may be substituted by F or Cl.

m is independently 0, 1, 2, or 3.

R and R¹ are independent from each other, and are H, F, Cl, Br, I, CN, SCN, SF₅, or straight-chain alkyl or branched alkyl having one or two to 25 C atoms, and may be optionally monosubstituted or multisubstituted by F, Cl, Br, I, or CN, and here, one or two or more of non-neighboring CH₂ groups may be substituted by —O—, —S—, —NH—, —NR⁰—, —CO—, —COO—, —OCO—, —O—COO—, —S—CO—, —CO—S—, —CH═CH—, or —C≡C—, where two of O and/or S atom are not directly bonded to each other.

From the viewpoint of improving solubility to the liquid crystal composite, in chemical formula (1), X, Y¹, and Y² are preferably a straight-chain or branched alkyl having one to 25 C atoms. From the viewpoint of suppressing a decrease in the upper limit of the temperature of the chiral liquid crystal phase due to the addition of the chiral compound, Y¹, and Y² are preferably mesogen M.

Y¹ and Y² are preferably introduced at position 6 or position 7, position 6′, or position 7′ of the binaphthyl skeleton.

W is preferably an alkylene group having one or three C atoms, and more preferably an alkylene group having one C atom where the H atom bonded to the C atom is substituted by mesogen M.

For example, the photoracemized chiral compound expressed by chemical formulas (1-A-1) to (1-A-10) or (1-B-1) to (1-B-10) can be specifically preferably used.

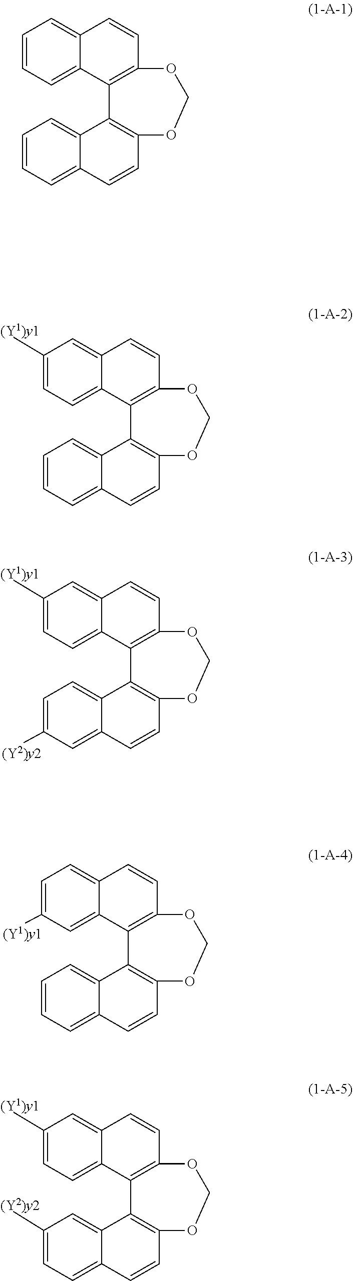

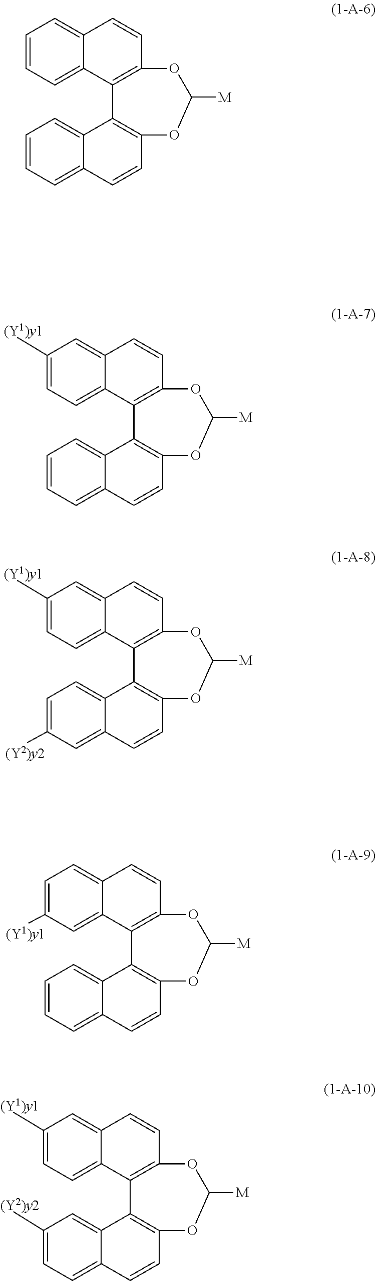

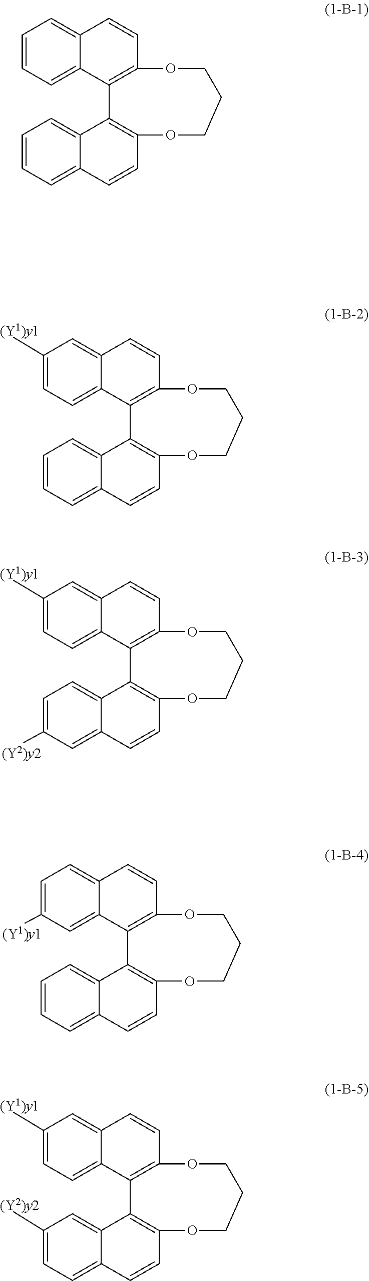

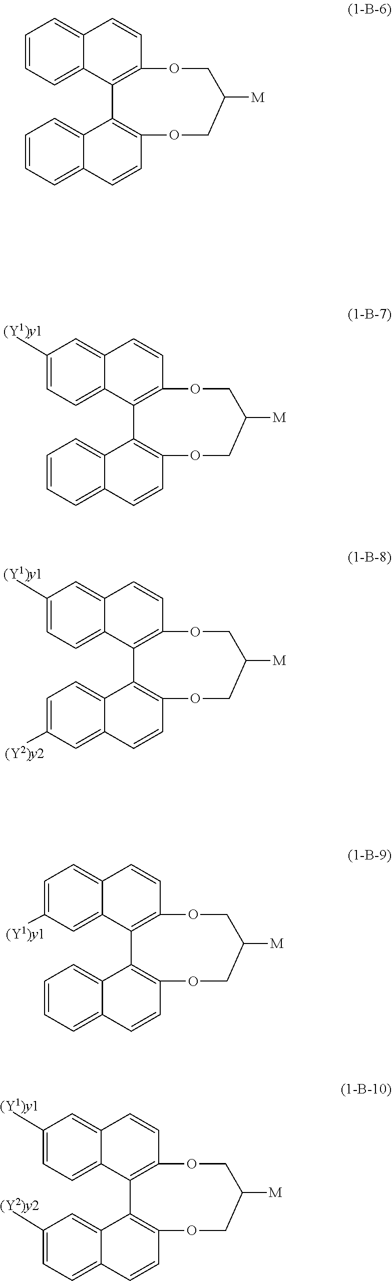

In chemical formulas (1-A-1) to (1-A-10) and (1-B-1) to (1-B-10), Y¹, Y², y1, y2, and M are as defined in chemical formula (1).

For the chiral compound used in the technology described herein, such chiral compounds are preferably used in which the racemization velocity under the conditions in which the external stimulus that induces the polymerization of the polymerizable monomer is given is smaller than the polymerization reaction velocity of the polymerizable monomer. Specifically, after the polymer network is formed, the liquid crystal component preferably maintains 80% or more of the initial chirality, and more preferably, 90% or more of chirality. With this configuration, during the polymerization of the polymerizable monomer, the chirality of the liquid crystal component is maintained at nearly constant, and hence a polymer network is formed in which the structure of the chiral liquid crystal phase before the polymerization of the monomer is excellently reflected. Then, after the formation of the polymer network is completed, the chirality of the liquid crystal component can be decreased by racemizing the chiral compound remaining in the liquid crystal component. Consequently, the liquid crystal phase showing useful optical properties unique to the chiral liquid crystal phase with a low drive voltage and a low hysteresis can be exhibited by a significantly simple method.

In the first embodiment, an example is shown in the case in which a chiral compound in chemical formula (1-A-1) is used as a chiral compound that is racemized by light. As described above, in the first embodiment, a photopolymerizable monomer is used as a polymerizable monomer. In this case, in order to advance the photopolymerization of the polymerizable monomer faster than the photoracemization of the chiral compound by the application of light that induces the polymerization of the monomer, or in order to increase the difference in the velocity between these reactions, the wavelength of light that induces racemization may be shifted from the wavelength of light suitable for photopolymerization to the long wavelength side or the short wavelength side. For example, molecule design can be considered such that the absorption wavelength of the chiral compound is shortened. The chiral compound in chemical formula (1-A-1) used in the first embodiment absorbs light at a wavelength of from 280 nm to 350 nm or ultraviolet rays around these wavelengths for racemization, while racemization velocity is relatively slow.

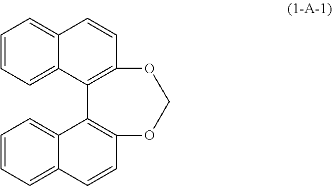 [SMILES: c1ccc2c3c(ccc2c1)OCOc1ccc2ccccc2c1-3]

Liquid Crystal Molecules

Liquid crystal molecules used in the technology

described herein show liquid crystal properties. The liquid crystal molecules have a function in which the molecules exhibit a chiral liquid crystal phase together with a chiral compound until the formation of the polymer network is completed, and in the polymer/liquid crystal composite material having the polymer network completely formed, the liquid crystal molecules are present in the achiral liquid crystal component and molecularly orientated along the polymer network, and then exhibit optical properties similar to the chiral liquid crystal phase.

The liquid crystal composite according to the technology described herein includes one kind or two kinds or more of liquid crystal molecules showing liquid crystal properties. For the liquid crystal molecules, an appropriate one is selected from known liquid crystal molecules, and can be used alone or in the combination of two kinds or more.

Examples of liquid crystal molecules used in the technology described herein that can be used include nematic liquid crystals or smectic liquid crystals. Rod-shaped nematic liquid crystals that present a nematic phase are preferably used. As described above, the nematic liquid crystals are sorted into positive liquid crystals and negative liquid crystals based on dielectric anisotropy. However, in the technology described herein, positive or negative nematic liquid crystals can be used according to appropriate selection suitable for desired properties or the direction of an electric field to be applied to the liquid crystal layer.

From the viewpoint of improving contrast, liquid crystal molecules used in the technology described herein are preferably liquid crystal molecules having a large dielectric anisotropy and a large refractive index anisotropy. Specifically, one kind of positive liquid crystal molecules having three to five ring structures and having —CF₂O— group as a linking group is preferably used. Note that the term “ring structure” referred here is a ring group including a benzene ring, naphthalene ring, cyclohexene ring, bicyclooctane ring, cyclohexane ring, and any other ring group, and ring structures including at least two rings, such as a condensed ring hydrocarbon and a crosslinked ring hydrocarbon, are also counted as one.

The liquid crystal composite according to the technology described herein is a liquid crystal composite that can exhibit a chiral liquid crystal phase. However, liquid crystal molecules themselves do not necessarily have optical activity. The liquid crystal composite only has to be a composite that can exhibit a chiral liquid crystal phase in the presence of the optical activity compound. As described above, the chiral compound, liquid crystal molecules showing liquid crystal properties may be used. From, the viewpoint of easy control over exhibition of optical properties, for example, achiral liquid crystal molecules are preferably used.

In the first embodiment, achiral nematic liquid crystal molecules are used as liquid crystal molecules. Note that as described above, for the polymerizable monomer, an achiral polymerizable monomer having mesogen is also used.

Other Components Included in the Liquid Crystal Composite

The liquid crystal composite according to the technology described herein may include a solvent, various monomers, oligomers, polymers, an antioxidant, an ultraviolet absorption agent, a curing agent, a catalyst, a stabilizer, a dichroic pigment, and a photochromic compound, for example, within the range not degrading the effect of the technology described herein.

From the viewpoint of reliable and quick polymerization of the polymerizable monomer, the liquid crystal composite according to the technology described herein preferably includes a polymerization initiator that starts the polymerization of the polymerizable monomer. The content of the polymerization initiator included in the liquid crystal composite can be in a range of from 0.1 parts by weight to 20 parts by weight to the polymerizable monomer 100 parts by weight, for example. For the polymerization initiator, a photoradical polymerization initiator, thermal radical polymerization initiator, photo cation radical polymerization initiator, and any other initiator can be used.

In the first embodiment, the external stimulus that induces the polymerization of the polymerizable monomer and the external stimulus that induces the racemization of the chiral compound are the application of light. The chiral compound in chemical formula (1-A-1) used in the first embodiment is racemized with the application of ultraviolet rays having a relatively short wavelength. Thus, for the polymerization initiator, a long wavelength absorption photoradical initiator is used. The photoradical initiator absorbs ultraviolet rays on a relatively long wavelength side and generates radicals.

Method of Producing the Polymer/Liquid Crystal Composite Material

The polymer/liquid crystal composite material according to the technology described herein can be prepared by preparing a liquid crystal composite, forming a polymer network, and racemizing using the liquid crystal composite including the components. In the following, the processes will be in turn described.

Preparing Liquid Crystal Composite

The polymerizable monomer, the chiral compound, the liquid crystal molecule, and the polymerization initiator are put into a container, and are mixed until components are dissolved. Mixing can be performed using a given method and devices under the conditions in which the functions of the components are not degraded.

In the first embodiment, the external stimulus is the application of light in any case. Thus, the liquid crystal composite made up of the components is heated to the temperature at which the composite presents an isotropic phase, the composite is stirred and shaken, and hence an almost homogeneous liquid crystal composite can be obtained.

Forming Polymer Network

1. Chiral Liquid Crystal Phase Exhibition Process

The temperature o f the almost homogeneous liquid crystal composite obtained by preparing the liquid crystal composite is adjusted to exhibit a predetermined chiral liquid crystal phase. In the first embodiment, the temperature is a temperature at which the liquid crystal composite exhibits the blue phase. Adjusting the temperatures to exhibit these predetermined phases may be achieved by a method with which the temperature of the liquid crystal composite is set lower than the temperature at which the target phases are exhibited and then the temperature is increased or by a method with which the temperature of the liquid crystal composite is increased to a higher temperature and then the temperature of the liquid crystal composite is decreased. In the case in which it is necessary to achieve polymerization in a blue phase and to improve reflectance, the temperature is preferably slowly decreased to exhibit the blue phase.

2. Monomer Polymerization Process

The external stimulus that induces the polymerization of the monomer is imparted to polymerize a polymerizable monomer while the liquid crystal composite exhibits a predetermined chiral liquid crystal phase by the chiral liquid crystal phase exhibition process, and then a polymer network having the chiral liquid crystal phase as a template is formed.

In the first embodiment, an example is shown in the case in which the polymer network is formed with the blue phase presented in the liquid crystal composite, and a PSBP is first obtained. The exhibited temperature range of the blue phase is considerably narrow. Thus, in the case in which the blue phase fails to be kept in the process of advancing polymerization, the temperature may be reset to the temperature at which the blue phase is presented by adjusting the temperature.

The point in this process is that the polymerization velocity of the polymerizable monomer is set faster than the racemization velocity of the chiral compound and the formation of the polymer network is completed before the chirality of the liquid crystal component is greatly changed, i.e., while the chirality is kept at a nearly constant.

In the first embodiment, since the photopolymerizable monomer and the photoracemized chiral compound are used, preferably, the racemization of the chiral compound is not easily advanced under the conditions in which the light that induces the polymerization of the monomer is applied. In order to achieve this, preferably, one of the wavelength of light that induces the polymerization of the monomer and the wavelength of light that induces the racemization of the chiral compound or both wavelengths are shifted such that the wavelength of light that induces the polymerization of the monomer is different from the wavelength of light that induces the racemization of the chiral compound, and then the light including no light having a wavelength that induces racemization is applied.

As described above, the first embodiment uses the chiral compound in chemical formula (1-A-1) that is racemized with the application of ultraviolet rays having a relatively short wavelength and the long wavelength absorption photoradical initiator that starts polymerization with ultraviolet rays having a relatively long wavelength. Therefore, in this process, the application of near-ultraviolet rays from which light having a wavelength of less than 365 nm, for example, is removed accelerates the completion of the formation of the polymer network faster than the time point at which the chirality of the liquid crystal component is changed. Note that the chiral compound in chemical formula (1-A-1) used in the first embodiment has a relatively slow racemization velocity. Thus, even though the light to be applied in this process includes light having a wavelength of less than 365 nm, the polymerization of the polymerizable monomer can be advanced more in priority than the racemization of the chiral compound.

Racemizing

After the PSBP is prepared by preparing the polymer network, the chiral compounds remaining in the liquid crystal component is racemized. As described above, from the viewpoint of heat resistance of other members, the external stimulus that induces racemization is preferably the application of light. However, the wavelength of light to be applied in the racemizing only has to be a wavelength that can photoracemize the chiral compounds remaining in the liquid crystal component the PSBP. The wavelength may be the same or different from the wavelength of light to be applied in the monomer polymerization process. After the formation of the polymer network is completed with the chirality of the liquid crystal component maintained at nearly constant, the chiral compound is racemized to form the liquid crystal component to be an achiral liquid crystal component. Note that since the racemization of the chiral compound is positively advanced after the formation of the polymer network is completed, the polymerization velocity of the monomer is any velocity under the conditions in which the light that induces racemization is applied.

The first embodiment uses the chiral compound in chemical formula (1-A-1) that is racemized with the application of ultraviolet rays having a relatively short wavelength and the long wavelength absorption photoradical initiator. After the formation of the polymer network is completed with the application of near-ultraviolet rays in the previous process, the application of ultraviolet rays on the short wavelength side enables the racemization of the chiral compound remaining in the liquid crystal component. Here, as described above, the two reactions can also be simultaneously started by the application of light that induces the polymerization of the monomer. However, in this case, the conditions are necessary in which the racemization velocity of the chiral compound is sufficiently small under the application of light and the polymerization of the monomer, i.e., the formation of the polymer network is completed before the racemization of the chiral compound. This configuration is preferable from the viewpoint at which the monomer polymerization process and the racemizing can be performed with the application of the same light, leading to simple processes.

In this process, the preparation of the BPTN made up of the polymer network formed using the blue phase as a template and the achiral liquid crystal component is completed.

Polymer/Liquid Crystal Composite Material

The polymer/liquid crystal composite material according to the first embodiment formed as described above includes the achiral liquid crystal component and the polymer network, and can exhibit the BPTN. Note that on the polymer/liquid crystal composite material according to the technology described herein, the polymer network and the liquid crystal component only have to be present together, and a part or all of the polymer that forms the network is formed may be in phase separation from the liquid crystal component.

Achiral Liquid Crystal Component

The liquid crystal component included in the polymer/liquid crystal composite material according to the technology described herein is the achiral liquid crystal component, including the liquid crystal molecules showing liquid crystal properties and the racemate of the chiral compound. The racemate is generated from the chiral compound included in the liquid crystal composite by racemization. Note that as described above, in the present specification, the achiral liquid crystal component is not limited to components having no optical activity at all, and the racemate is not limited to a perfect equal part mixture of the enantiomer. The racemate only has to be ones that do not interfere with exerting the effect of the technology described herein. The liquid crystal molecules are molecularly oriented similarly to the liquid crystal molecules in the blue phase using the polymer network as a template described later, and exhibit a BPTN. In order to achieve a low drive voltage, the content ratio of the liquid crystal component in the polymer/liquid crystal composite material is preferably high. However, the content is preferably in a range of from 75 percent by weight to 95 percent by weight to the total amount.

Polymer Network

The polymer network included in the polymer/liquid crystal composite material according to the technology described herein molecularly orients the liquid crystal molecules included in the liquid crystal component similarly to the liquid crystal molecules in a predetermined chiral liquid crystal phase. The polymer network according to the first embodiment is formed with the blue phase exhibited. The liquid crystal molecules are oriented similarly to the liquid crystal molecules in the blue phase due to this polymer network, and hence an optically isotropic BPTN is exhibited.

### Operation and Effect of the First Embodiment

The liquid crystal composite according to the first embodiment used for the preparation of the BPTN includes the liquid crystal molecules showing liquid crystal properties, the polymerizable monomer polymerized by an external stimulus, the polymerizable monomer having substantially no optical activity, and the chiral compound that has an optical activity and is racemized by an external stimulus.

The liquid crystal composite used in the first embodiment includes the liquid crystal molecules and the chiral compound, and hence the liquid crystal component including the molecules and the compound has chirality, and can exhibit the chiral liquid crystal phase. In the first embodiment, an external stimulus is given with the blue phase presented in the liquid crystal composite, the polymerizable monomer is polymerized, and then the polymer network is formed as the blue phase is used as a template.

The chiral compound that imparts chirality to the liquid crystal component is racemized due to an external stimulus. Thus, am external stimulus is given to the liquid crystal component, this decreases the chirality of the liquid crystal component to form an achiral liquid crystal component. Consequently, the BPTN can be prepared.

In the BPTN thus prepared, the liquid crystal molecules are molecularly oriented similarly to the liquid crystal molecules in the blue phase based on the polymer network. The BPTN is optically isotropic, and hence no alignment film is necessary, and the response speed is considerably fast. The liquid crystal molecular orientation similar to the PSBP is stabilized due to the presence of the polymer network, and hence the exhibited temperature range of the BPTN is also widened. In the BPTN, the liquid crystal component is achiral. Thus, the twisting force that acts on the liquid crystal molecules in the component is small, the molecular orientation can be changed with a small voltage, and hence a low drive voltage is achieved.

As described above, with the use of the liquid crystal composite according to the first embodiment, the BPTN can be stably exhibited in a wide temperature range by a simple method with which an external stimulus is given to the liquid crystal composite. The BPTN shows useful optical properties, such as wide viewing angle properties and quick response characteristics, unique to the blue phase, and the BPTN achieves a low drive voltage and a low hysteresis.

In the first embodiment, as a polymerizable monomer, a monomer having mesogen is used.

This configuration avoids an excessive decrease in the upper limit of the temperature of the blue phase before the polymer network is formed.

In the first embodiment, the photopolymerizable monomer is used as the polymerizable monomer and the photoracemized chiral compound is used as the chiral compound. The liquid crystal composite further includes a polymerization initiator that absorbs light having a wavelength in a specific range and starts the polymerization of the polymerizable monomer.

With this configuration, even in the configuration including another member having a low heat resistance, the formation of the polymer network or racemization can be performed with no influence on such member. As described above, in the case in which the external stimulus is the application of light, the polymerization of the monomer is preferably advanced faster than the racemization of the chiral compound under the conditions in which light is applied as an external stimulus that induces the polymerization of the monomer. In the first embodiment, the chiral compounds that are racemized with ultraviolet rays having a relatively short wavelength is used, the long wavelength absorption photoradical polymerization initiator that absorbs ultraviolet rays having wavelengths longer than the light that induces racemization and generates radicals is used in combination, and near-ultraviolet rays are applied for photopolymerization of the monomer. With this configuration, the advance of racemization in the monomer polymerization process is suppressed, the chirality of the liquid crystal component is maintained at nearly constant, and hence the polymer network is formed which excellently reflects the structure of the chiral liquid crystal phase before monomer polymerization is started. By a significantly simple method with which after the formation of the polymer network is completed, the chiral compounds remaining in the liquid crystal component are racemized by the application of ultraviolet rays on the short wavelength side are applied, the liquid crystal phase showing useful optical properties unique to the chiral liquid crystal phase with a low drive voltage and a low hysteresis can be exhibited.

In the first embodiment, a photoracemized binaphthyl derivative is used as the chiral compound.

The photoracemized binaphthyl derivative has a large HTP, and can induce a desired helical pitch with addition of a small amount. The photoracemized binaphthyl derivative has an excellent compatibility with liquid crystal molecules, and can easily prepare the liquid crystal composite.

The photoracemized binaphthyl derivative used in the first embodiment is expressed by chemical formula (1-A-1).

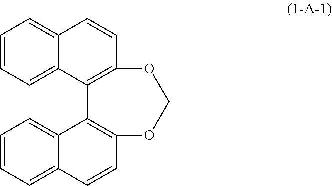 [SMILES: c1ccc2c3c(ccc2c1)OCOc1ccc2ccccc2c1-3]

In the polymer/liquid crystal composite material according to the first embodiment, the racemate included in the achiral liquid crystal component is a racemate is a photoracemized binaphthyl compound in chemical formula (1-A-1).

The photoracemized binaphthyl compound in chemical formula (1-A-1) has a large HTP, has excellent compatibility with nematic liquid crystal molecules typically used, and also has a relatively slow racemization velocity. Thus, the racemization of the compound is hardly advanced during the polymerization of the polymerizable monomer, and the compound can easily maintain the chirality in the liquid crystal component at nearly constant until the formation of the polymer network is finished. The chiral compound in chemical formula (1-A-1) can give priority to the polymerization of the polymerizable monomer more than the racemization of the chiral compound also under the conditions in which the light that induces the polymerization of the monomer is applied. Thus, this configuration is also possible in which the polymerization of the monomer and the racemization of the chiral compound are simultaneously started by the application of the light that induces the polymerization of the monomer, the formation of the polymer network is completed before racemization is advanced to reduce the chirality of the liquid crystal component is reduced, and racemization is performed as the application of the light is continued. The photoracemized binaphthyl compound is preferable from, the viewpoint of simplifying a method of producing the polymer/liquid crystal composite material.

The polymer/liquid crystal composite material according to the first embodiment includes an achiral liquid, crystal component and a polymer network. The achiral liquid crystal component includes liquid crystal molecules showing liquid crystal properties and a racemate of a chiral compound. The polymer network orients the liquid crystal molecules similarly to liquid crystal molecules in a blue phase. The racemate is generated by racemization of a chiral compound included in the liquid crystal component due to an external stimulus.

The polymer/liquid crystal composite material according to the first embodiment is prepared by giving an external stimulus to a liquid crystal composite including liquid crystal molecules showing liquid crystal properties, a polymerizable monomer polymerized by an external stimulus, the polymerizable monomer having substantially no optical activity, and a chiral compound that has an optical activity and is racemized by an external stimulus. The achiral liquid crystal component includes the liquid crystal molecules and the racemate generated by racemization of the chiral compound with an external stimulus. The polymer network is formed by polymerization of the polymerizable monomer due to an external stimulus with a predetermined chiral liquid crystal phase presented in the liquid crystal composite.

With this configuration, the BPTN can be prepared by a simple method with which after the PSBP is prepared, the chiral compound that contributes to exhibiting the blue phase is racemized with an external stimulus. The BPTN thus prepared has a characteristic that the racemate of the chiral compound is included in the liquid crystal component.

The polymer/liquid crystal composite material according to the first embodiment can be produced by a method of producing the polymer/liquid crystal composite material. The method includes preparing a liquid crystal composite, forming a polymer network, and a racemizing. In preparing a liquid crystal composite, a liquid crystal composite including liquid crystal molecules showing liquid crystal properties, a polymerizable monomer having substantially no optical activity and polymerized by an external stimulus, and a chiral compound having an optical activity and racemized by an external stimulus, is prepared. In forming the polymer network, the polymer network is formed by imparting an external stimulus to the polymerizable monomer to polymerize the polymerizable monomer with the blue phase presented in the liquid crystal composite. In the racemizing, the chiral compound is racemized by imparting an external stimulus to the chiral compound. Here, the polymer network molecularly orients the liquid crystal molecules included in the liquid crystal component similarly to the liquid crystal molecules in the blue phase. The liquid crystal component has no polymer network in the liquid crystal composite. The external stimulus that polymerizes the polymerizable monomer is selected such that the polymerization velocity of a polymerizable monomer is faster than the racemization velocity of the chiral compound and the chirality of the liquid crystal component is maintained at nearly constant before the start of the polymerization of the polymerizable monomer until the formation of the polymer network is completed, under the conditions in which the external stimulus is imparted.

According to the configuration of the first embodiment,

the polymerizable monomer is polymerized prior to the racemization of the chiral compound, the polymer network is formed with the chirality of the liquid crystal component kept at nearly constant, and hence the polymer network that reflects the structure of the blue phase before monomer polymerization is formed. The chiral compound included in the liquid crystal component in the PSBP this obtained is racemized, the liquid crystal component is formed into an achiral liquid crystal component, and hence the BPTN can be prepared. As described above, the BPTN can be prepared by a significantly simple method with which am external stimulus is imparted to the liquid crystal composite.

In the BPTN prepared by the first embodiment, the liquid crystal molecules are molecularly oriented so as to present a blue phase. A quick response to the degree that field sequential drive is possible can be achieved. Such a blue phase shows optical isotropy, and hence the BPTN has a wide viewing angle and needs no alignment process. Similarly to the PSBP, in the BPTN, the polymer network stabilizes the phase, and hence the exhibited temperature range of the BPTN showing optical properties similar to the PSBP is widened. Unlike the PSBP, in the BPTN, the liquid crystal component is an achiral liquid crystal component, and hence a low drive voltage and a low hysteresis are achieved. The polymer/liquid crystal composite material that exhibits such a BPTN is specifically useful for a liquid crystal display element applied with field sequential color mode, a liquid crystal display element using a layer patterned with a wavelength conversion material that is a suitable wide viewing angle the liquid crystal driving mode, and a liquid crystal lens using refractive index changes, for example.

### First Embodiment-1: A Liquid Crystal Display Device Including a Liquid Crystal Layer Formed of the BPTN

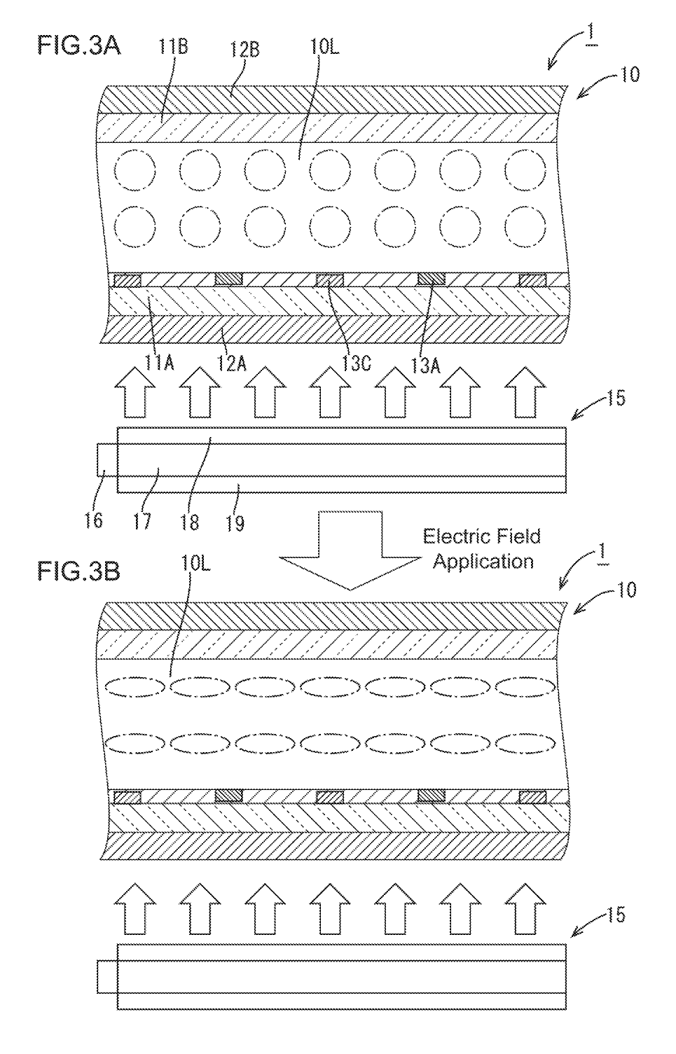

Referring to FIGS. 3A and 3B, a first embodiment-1 will be described. In the first embodiment-1, an example of a liquid crystal display device having a liquid crystal cell is shown. The cell includes a liquid crystal layer formed of the BPTN prepared in the first embodiment and a unit that applies an electric field to this liquid crystal layer.

Liquid Crystal Display Device 1

The liquid crystal display device according to the technology described herein can be a typical liquid crystal display device having a known schematic configuration. In the first embodiment-1, an example of a liquid crystal display device 1 is shown. The display device 1 includes a panel-like liquid crystal cell 10 and a backlight unit 15 stacked on one of the plate surfaces of the liquid crystal cell 10.

Liquid Crystal Cell 10

A liquid crystal element according to the technology described herein can be a known schematic configuration. In the first embodiment-1, as illustrated in FIGS. 3A and 3B, a liquid crystal cell 10 is described as an example, including a pair of substrates 11A and 11B disposed opposite to each other, a liquid crystal layer 10L sandwiched between these two substrates, and polarizers 12A and 12B respectively attached to the substrates 11A and 11B. The liquid crystal cell 10 is an example of a liquid crystal element that performs display using a birefringence change in the liquid crystal layer 10L.

Liquid Crystal Layer 10L

The liquid crystal element according to the technology described herein includes a liquid crystal layer formed of the polymer/liquid crystal composite material according to the technology described herein. The liquid crystal layer 10L according to the first embodiment-1 is formed of the BPTN prepared in the first embodiment. Liquid crystal molecules included in the liquid crystal layer 10L (included in the liquid crystal composite or the liquid crystal component of the first embodiment) preferably have positive dielectric anisotropy. In the first embodiment-1, an example is described in which the liquid crystal molecules included in the liquid crystal layer 10L are positive nematic liquid crystal molecules.

Substrates 11A and 11B

The substrates 11A and 11B each include a transparent substrate formed of a glass plate excellent in transparency, for example. At least two films are stacked on the transparent substrate by known photolithography, for example. In the stacked structure, at least two electrodes are formed. The at least two electrodes are composed of a conductive film and connected to an external power supply, for example. The voltage across the electrode is controlled to apply an electric field to the liquid crystal layer 10L. When an electric field at a threshold or more is applied, the alignment of the liquid crystal molecules in the liquid crystal layer 10L is changed. In the first embodiment-1, as an example, the substrates 11A and 11B are described in which the liquid crystal layer 10L is applied with an electric field acting on substantially in parallel with the direction the plate surfaces of the substrates 11A and 11B (in the lateral direction).

In the substrates, a first substrate stacked with the backlight unit 15, described later, is the pixel electrode substrate (an array substrate, an active matrix substrate, or an element substrate) 11A. On the pixel electrode substrate 11A, a switching element (e.g. a TFT) connected to a source wire and a gate wire orthogonal to each other, a pixel electrode 13A connected to the switching element, and a common electrode 13C are provided. The pixel electrode 13A and the common electrode 13C (an example of an electric field application unit) are formed using transparent conductive materials. These electrodes 13A and 13C may be configured in which the electrodes 13A and 13C have a comb tooth-shape with a protrusion non-continuously protruding from a rectangular plate-like base portion, for example, the protrusions of the electrodes protrude from the base portions disposed along the opposing side edges of the liquid crystal cell 10 from both sides toward the base portion of the second electrode, and the protrusions are alternately disposed.

In the substrates, the second substrate is the counter-substrate 11B. The counter substrate 11B may include a color filter layer having colored parts, red (R), green (G), and blue (B), for example, disposed in a predetermined array. Also in the configuration with no color filter layer, color display is shown by field sequential color mode. Here, the counter substrate 11B with no color filter layer is described as an example.

At the position in contact with the liquid crystal layer 10L on the inner surfaces (where the liquid crystal layer 10L is disposed) of the substrates 11A and 11B, am alignment film may be formed. The alignment film regulates the alignment state of the liquid crystal molecules in the liquid crystal layer 10L with application of no electric field. In the first embodiment-1, since the liquid crystal layer 10L is formed of am optically isotropic BPTN, the alignment film may not be provided. Here, the substrates 11A and 11B with no alignment film is described as an example.

On the outer surfaces (the surfaces opposite to the surfaces on which the liquid crystal layer 10L is disposed) of the substrates 11A and 11B, polarizers 12A and 12B are respectively attached. The polarizers 12A and 12B transmit only light vibrating in a specific direction in light applied from the backlight unit 15, described later. The deflection direction by the polarizers 12A and 12B can be optional. From the viewpoint of improving the contrast of display images, a so-called crossed Nicols arrangement is preferable in which the polarization direction of the polarizer 12A and the polarization direction the polarizer 12B form an angle of 91 degrees. In the first embodiment-1, the liquid crystal cell 10 where these two polarizers 12A and 12B are disposed in crossed Nicols arrangement is described as an example. Note that a retardation plate, for example, may be disposed between the substrates 11A and 11B and the polarizers 12A and 12B as necessary.

Backlight Unit 15

The backlight unit 15 that applies light to the liquid crystal cell 10 can be a typical backlight unit having a known schematic configuration. The backlight unit 15 has a light source 16 formed of light emitting diodes (LEDs). The backlight unit 15 may be a direct type backlight unit or may be an edge light type backlight unit. In the direct type backlight unit, a light source is disposed directly below the image display surface of the liquid crystal cell 10. In the edge light type backlight unit, a light source is disposed along one or at least two side edges of the image display surface. Here, the edge light type backlight unit is described as an example. The backlight unit 15 has light guide plate 17, an optical sheet 18, and a reflective sheet 19. The light guide plate 17 enters light from the light source, guides the light to the position apart from the light source, and emits the light as surface light toward the liquid crystal cell 10 side. The optical sheet 18 is disposed between the light guide plate 17 and the liquid crystal cell 10 and imparts optical functions to the light emitted from the light guide plate 17. The reflective sheet 19 is laid on the plate surface of the light guide plate 17 where the optical sheet 18 is not disposed, and reflects off the light emitted from the light-guide plate 17 to the plate surface side.

### Operation and Effect of the First Embodiment-1

FIGS. 3A and 3B are images of birefringence change in the liquid crystal cell 10 according to the first embodiment-1. FIG. 3A is the image with application of no electric field, and FIG. 3B is the image with application of no electric field.

The liquid crystal layer 10L is formed of the BPTN. With application of no electric field, the liquid crystal layer 10L is optically isotropic. The index ellipsoid has a spherical shape (in FIG. 3A, depicted by circles in an alternate long and short dash line). Therefore, the light that is applied from the backlight unit 15, transmitted through the polarizer 12A on the pixel electrode substrate side, and entered to the liquid crystal layer 10L is transmitted in the liquid crystal layer 10L as it is. Thus, almost no light can be transmitted through the polarizer 12B on the counter substrate side in crossed Nicols arrangement.

Upon the application of a voltage across the pixel electrode 13A and the common electrode 13C using the external power supply, the electric field (the transverse electric field) substantially in parallel with the substrates 11A and 11B is imparted to the liquid crystal layer 10L, and the molecular orientation of liquid crystal molecules in the liquid crystal layer 10L is changed. The liquid crystal layer 10L uses positive nematic liquid crystal molecules having a positive dielectric constant. Thus, upon imparting a transverse electric field, liquid crystal molecules are oriented such that the major axis of the liquid crystal molecules is aligned nearly in parallel with the substrate, and the refractive index in parallel with the direction the substrate surface to the vertical direction of the substrate surface is increased to exhibit birefringence in FIG. 3B, depicted by ellipses in an alternate long and short dash line). Depending on a corresponding change in birefringence, the light that is applied from the backlight unit 15 and transmitted through the polarizer 12B on the pixel electrode substrate side, and entered to the liquid crystal layer 10L can be transmitted through the polarizer 12B on the counter substrate side in crossed Nicols arrangement. The display state is changed corresponding to a change in the optical transparency of the liquid crystal cell 10, and images are displayed on the image display surface.

Here, in the liquid crystal display device 1 according to the first embodiment-1, since the liquid crystal layer 10L is formed of the BPTN, the liquid crystal layer 10L shows the optical properties similar to the blue phase in a relatively wide temperature range including ambient temperature, and the liquid crystal layer 10L shows quick response characteristics and wide viewing angle properties as well as a low drive voltage is achieved.

The liquid crystal display device 1 thus configured can be used for devices including television receiver devices, and display for personal computers, tablet terminals, mobile telephones, monitors, and any other device.

### First Embodiment-2: A Liquid Crystal Lens Including the Liquid Crystal Layer Formed of the BPTN

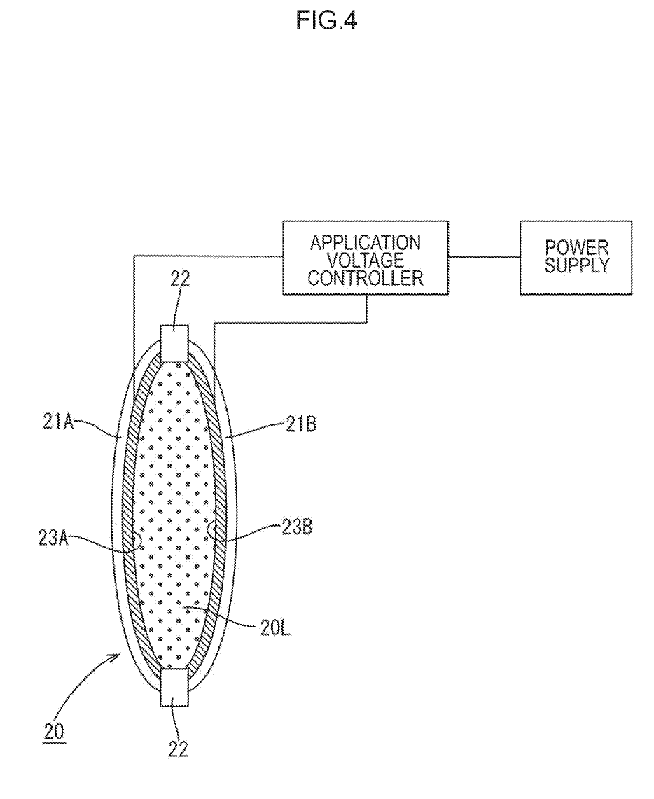

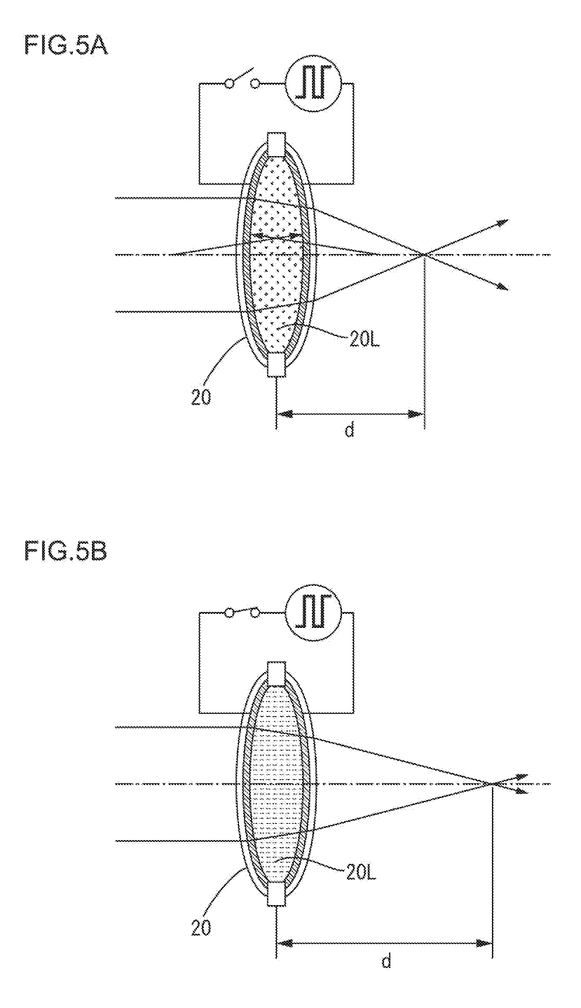

Referring to FIG. 4 and FIGS. 5A and 5B, a first embodiment-2 will be described. In the first embodiment-2, a liquid crystal lens is described as an example, including a liquid crystal layer formed of the BPTN prepared in the first embodiment, and a unit that applies an electric field to this liquid crystal layer.

Liquid Crystal Lens 20

The liquid crystal lens according to the technology described herein can be a known schematic configuration. For example, reference can be made to an example disclosed in Japanese Patent Application No. 2017-182468 using a PSBP, is used. In the first embodiment-2, as illustrated in FIG. 4, a liquid crystal lens 20 is described as an example including a pair of substrates 21A and 21B, an insulating member 22, and a liquid crystal layer 20L. The curved substrates 21A and 21B are disposed facing to each other such that a convex lens type hollow is formed in the inside. The insulating member 22 sandwiched between the coupling parts of the substrates. The liquid crystal layer 20L sealed in the inside of the convex lens type hollow between the substrates. The liquid crystal lens 20 is an example of a liquid crystal element using a change in the refractive index of the liquid crystal layer 20L.

Liquid Crystal Layer 20L

The liquid crystal layer 20L is formed of the BPTN prepared in the first embodiment. Note that the liquid crystal molecules included in the liquid crystal layer 20L may be a positive type or a negative type. The liquid crystal molecules having an appropriate dielectric anisotropy can be selected suitable for the direction of a desired change in the refractive index of the liquid crystal layer 20L. In the first embodiment-2, an example is shown in the case in which the liquid crystal molecules included in the liquid crystal layer 20L are negative nematic liquid crystal molecules.

Substrates 21A and 21B

The substrates 21A and 21B each include a transparent substrate formed of a glass plate excellent in transparency, for example. The substrates 21A and 21B form a convex lens shape in which the center part is most bulged along the minor axis. In the first embodiment-2, the substrates 21A and 21B are described as an example. The substrates 21A and 21B are formed such that the liquid crystal layer 20L is applied with am electric field acting substantially in parallel with the direction of the focal point of the liquid crystal lens 20. In the first embodiment-2, in the configuration, a first electrode 23A formed of a conductive film is formed on the curved surface of the first substrate 21A on the liquid crystal layer 20L side, and a second electrode 23B similarly formed of a conductive film is formed on the curved surface of the second substrate 21B on the liquid crystal layer 20L side. On the connecting parts of the substrates 21A and 21B, an insulating member 22 is disposed. The first and second electrodes 23A and 23B are connected to the external power supply, for example. A voltage applied across the electrodes is controlled to apply an electric field to the liquid crystal layer 20L. Upon the application of an electric field to the liquid crystal layer 20L and the application of an electric field at a threshold or more, the molecular orientation of liquid crystal molecules in the liquid crystal layer 20L is changed, and the refractive index of the liquid crystal layer 20L is changed.

### Operation and Effect of the First Embodiment-2

FIGS. 5A and 5B are schematic optical paths in the liquid crystal lens 20. FIG. 5A is the image with application of no electric field, and FIG. 5B is the image with application of no electric field. The liquid crystal layer 20L is formed of the BPTN, and is optically isotropic with application of no electric field. Thus, light entered to the liquid crystal lens 20 shows refraction depending on the shapes of the substrate 21B and the substrate 21A. Upon the application of a voltage across the first and second electrodes 23A and 23B using the external power supply, a nonuniform electric field is formed on the liquid crystal layer 20L, and the molecular orientation of liquid crystal molecules in the liquid crystal layer 20L is changed suitable for the intensity of this electric field. That is, the molecular orientation is gradually changed because of the positions of the liquid crystal molecules in the liquid crystal layer 20L, and a distance a to the focal point of the light entered to the liquid crystal lens 20 is changed. In the first embodiment-2, the liquid crystal molecules are a negative type, and hence the refractive index in the application direction of the electric field becomes small, and the focal length a is prolonged. When the liquid crystal layer 20L includes positive liquid crystal molecules, the refractive index in the application direction of the electric field is increased.

As described above, in the liquid crystal lens 20 according to the first embodiment-2, since the liquid crystal layer 20L is formed of the BPTN, the focal length can be instantaneously changed with a small drive electric power. Thus, the liquid crystal lens 20 is suitable for focal point variable eyeglasses, for example. Since the liquid crystal lens 20 is a liquid crystal lens with no dependence on polarization, the use efficiency of light is high.

### Second Embodiment: A Polymer/Liquid Crystal Composite Material that Exhibits the SPAN

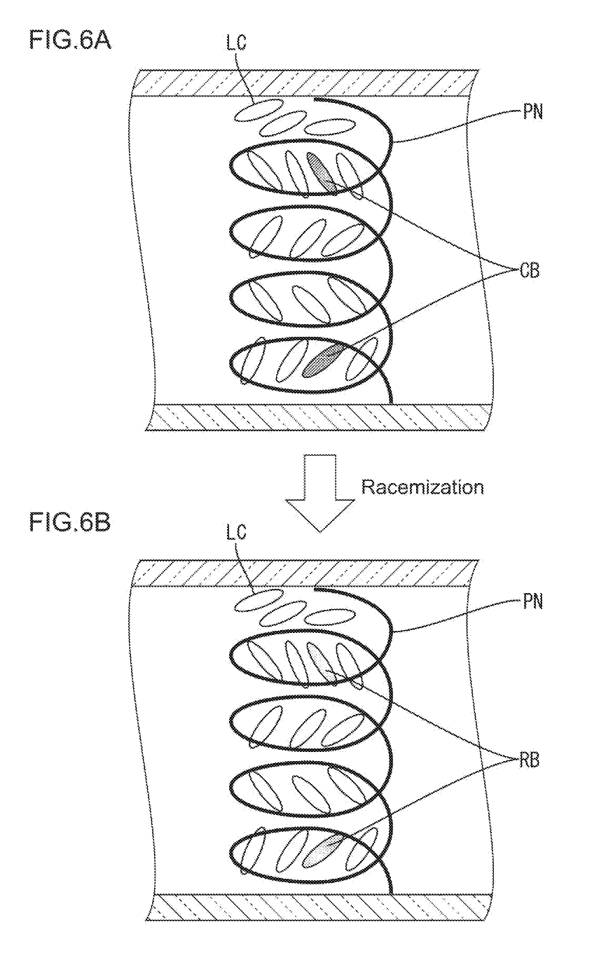

Referring to FIGS. 6A and 6B, a second embodiment will be described. In the second embodiment, a polymer/liquid crystal composite material that can exhibit a so-called SPAN is described as an example.

SPAN

In the present specification, the term “SPAN” is a phase including a polymer network PN and an achiral liquid crystal component in which liquid crystal molecules LC in the achiral liquid crystal component are oriented similarly to the liquid crystal molecules in the cholesteric phase using the polymer network PN as a template, and hence the phase is exhibited. Note that in FIGS. 6A and 6B, the polymer network PN is depicted in a spiral form. However, the polymer network PN is not necessarily in a spiral form.

In the second embodiment, after a PSCT formed of the polymer network PN and the chiral liquid crystal component is prepared, a chiral CB compound in the liquid crystal component is racemized to be a racemate RB, as illustrated in FIGS. 6A and 6B, and then a SPAN is prepared in which the liquid crystal component is an achiral liquid crystal component.

Liquid Crystal Composite

A polymer/liquid crystal composite material according to the second embodiment can be prepared using the liquid crystal composite including basically similar components used for the preparation of the polymer/liquid crystal composite material in the first embodiment. For the polymerizable monomer of the second embodiment, an appropriate one is selected from, publicly known polymerizable monomers used, for the PSCT, and can be used alone or in the combination of two kinds or more.

In the second embodiment, an example is shown in the case of using a liquid crystal composite including nematic liquid crystal molecules as liquid crystal molecules, an achiral polymerizable monomer having mesogen as a polymerizable monomer, a chiral compound in chemical formula (1-A-1) as a chiral compound, and a long wavelength absorption photoradical initiator that starts the polymerization of the polymerizable monomer.

Method of Producing the Polymer/Liquid Crystal Composite Material

The polymer/liquid crystal composite material according to the second embodiment can be prepared by a producing method including basically similar processes to the method of preparing the polymer/liquid crystal composite material in the first embodiment.

That is, preparing a liquid crystal composite, exhibiting a chiral liquid crystal phase, forming a polymer network, and racemizing are performed. In preparing the liquid crystal composite, the components made up of the liquid crystal composite are mixed to prepare the liquid crystal composite. In exhibiting the chiral liquid crystal phase, a predetermined chiral liquid crystal phase is exhibited. In forming the polymer network, an external stimulus is imparted with a predetermined chiral liquid crystal phase to polymerize a polymerizable monomer for forming the polymer network. In the racemizing, an external stimulus is imparted to racemize the chiral compound after the polymerization of the polymerizable monomer is started. However, as described in the first embodiment, under the conditions in which the formation of the polymer network is completed while the chirality of the liquid crystal component is kept at a nearly constant, forming the polymer-network and the racemizing may be simultaneously started.

In the second embodiment, forming the polymer network including the chiral liquid crystal phase exhibition process and the monomer polymerization process is performed under the conditions such that a cholesteric phase is exhibited and maintained as the chiral liquid crystal phase. The PSCT is prepared by such forming of a polymer network, and then the chiral compound in the liquid crystal component is racemized to obtain a SPAN including am achiral liquid crystal component.

The important points in preparation of the SPAN are almost similar to the preparation of the BPTN according to the first embodiment. In the monomer polymerization process, the wavelength, for example, of light to be applied is adjusted such that the racemization of the chiral compound included in the liquid crystal component is not advanced. Thus, the chirality of the liquid crystal component is maintained at nearly constant, and the polymer network is formed which excellently reflects the structure of the chiral liquid crystal phase before monomer polymerization is started. Therefore, a liquid crystal phase in which Bragg reflection before polymerization is maintained and a high reflectance is shown at a narrow selective reflection wavelength can be exhibited.

### Operation and Effect of the Second Embodiment

As described above, according to the second embodiment, a SPAN can be prepared by a simple method, the SPAN in which the selective reflection wavelength of Bragg reflection before polymerization and a high reflectance are maintained, useful optical properties unique to the cholesteric phase, and a low drive voltage and a small hysteresis are combined.

In the second embodiment, an external stimulus is imparted to the polymerizable monomer to polymerize the monomer with the cholesteric phase presented in the liquid crystal composite, and a polymer network using the cholesteric phase as a template is formed. In this process, the polymerizable monomer that contributes to forming the polymer network has substantially no optical activity, and hence the chirality of the liquid crystal component is hardly affected even though the formation of the polymer network is advanced. Adjustment is made such that the racemization of the chiral compound is hardly advanced during the monomer polymerization, and hence a reduction in the chirality of the liquid crystal component is also suppressed. As described above, the chirality of the liquid crystal component is maintained at nearly constant during the formation of the polymer network, and hence the helical structure of the cholesteric phase is maintained at nearly-constant. Therefore, the polymer network is formed using the cholesteric phase having a helical pitch at nearly constant as a template. In the SPAN obtained by the racemization of the chiral compound after the polymer network is formed, the liquid crystal molecules are oriented using this polymer network as a template. Thus, Bragg reflection at the selective reflection wavelength before polymerization is maintained. The chiral compounds remaining in the liquid crystal component are racemized after the formation of the polymer network is completed. Thus, the chirality of the liquid crystal component is reduced to from an achiral liquid crystal component. Thus, the twisting force of the liquid crystal molecules is reduced, and the drive voltage is reduced.

In the SPAN, since the liquid crystal molecules are molecularly oriented such that the molecules present a cholesteric phase similarly to the PSCT, a strong Bragg reflection is presented. This wavelength can shifted using an electric field, or reflection intensity can be adjusted. Since birefringence can be changed using an electric field, the SPAN is suitable for a display. At the same time, since the liquid crystal component is an achiral liquid crystal component, a low drive voltage and a low hysteresis are achieved. Such a polymer/liquid crystal composite material can be suitably used specifically for liquid crystal display elements using a wavelength conversion material for a color filter, and liquid crystal display elements using birefringence changes, and these devices can be substitution of cholesteric light modules.

### Second Embodiment-1: A Liquid Crystal Cell Including a Liquid Crystal Layer Formed of the SPAN

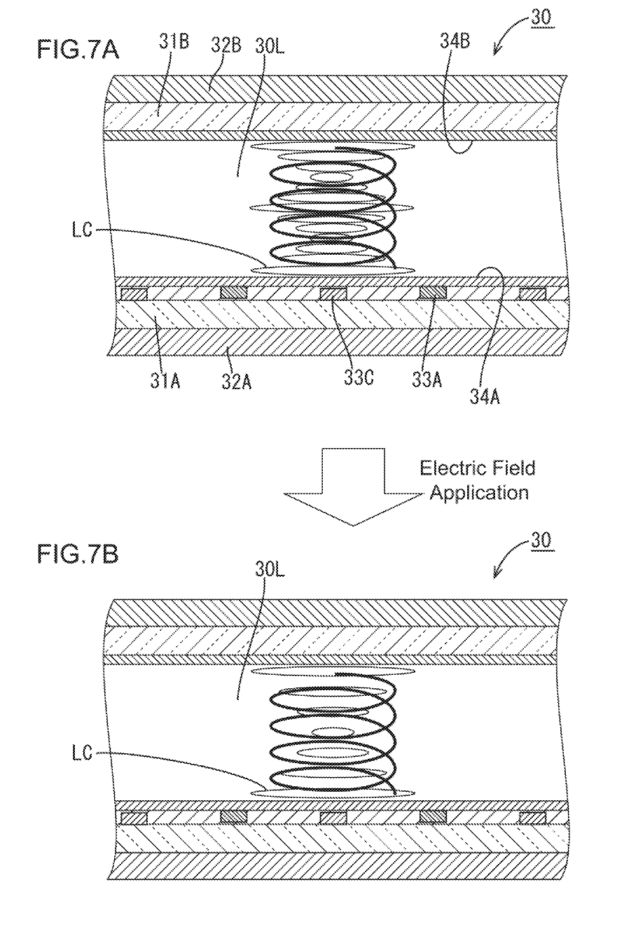

Referring to FIGS. 7A and 7B, a second embodiment-1 will be described. A liquid crystal cell 30 according to the second embodiment-1 has a liquid crystal layer and a unit that applies an electric field to this liquid crystal layer. The cell 30 is different from the liquid crystal cell 10 according to the first embodiment-1 in that the liquid crystal layer is formed of the SPAN prepared in the second embodiment.

Liquid Crystal Cell 30

As illustrated in FIGS. 7A and 7B, in the second embodiment-1, a liquid crystal cell 30 (an example of a liquid crystal element) is described as an example, including a pair of substrates 31A and 31B, a liquid crystal layer 30L sandwiched between these two substrates, and polarizers 32A and 32B attached to the substrates 31A and 31B in crossed Nicols arrangement.

Liquid Crystal Layer 30L

The liquid crystal layer 30L according to the second embodiment-1 is formed of the SPAN prepared in the second embodiment, including positive nematic liquid crystal molecules LC having positive dielectric anisotropy as liquid crystal molecules.

Substrates 31A and 31B

On the inner surfaces (where the liquid crystal layer 30L is disposed) of the substrates 31A and 31B, alignment films 34A and 34B are respectively disposed at the position in contact with the liquid crystal layer 30L. The alignment films 34A and 34B regulate the alignment state of the liquid crystal molecules LC in the liquid crystal layer 30L, and orient the molecules LC in a predetermined direction with no electric field applied. Examples of the alignment films 34A and 34B that can be used include known alignment films composed of a polyimide film, for example. The other points are the structure similar to the substrates 11A and 11B according to the first embodiment-1. The pixel electrode substrate 31B has a pixel electrode 33A and a common electrode 33C, and applies, to the liquid crystal layer 30L, an electric field acting on substantially in parallel with the substrate surface the direction (the lateral direction).

### Operation and Effect of the Second Embodiment-1

FIGS. 7A and 7B are images of a change in the molecular orientation of the liquid crystal molecules LC in the liquid crystal cell 30 according to the second embodiment-1. FIG. 7A is the image with application of no electric field, and FIG. 7B is the image with application of no electric field.

The liquid crystal layer 30L is formed of the SPAN. The liquid crystal molecules LC in the liquid crystal layer 30L are in planar alignment with application of no electric field. Thus, the liquid crystal molecules LC are aligned such that the molecules LC have a constant helical pitch in the direction perpendicular to the substrate surface, and molecules LC present Bragg reflection having a wavelength corresponding to the helical pitch as a selective reflection wavelength.

Upon the application of a voltage across the pixel electrode 33 and the common electrode 33C using an external power supply, an electric field (the transverse electric field) substantially in parallel with the substrates 31A and 31B is imparted to the liquid crystal layer 30L, and then the molecular orientation of the liquid crystal molecules LC in the liquid crystal layer 30L is changed. Upon imparting a transverse electric field, as illustrated in FIGS. 7A and 7B, the positive nematic liquid crystal molecules LC having a positive dielectric constant included in the liquid crystal layer 30L are spread in the vertical direction of the substrate surface to elongate the helical pitch, and the birefringence of the liquid crystal layer 30L is changed. The optical transparency of the liquid crystal cell 30 is changed depending on such a corresponding change in birefringence. For example, in the case in which the liquid crystal cell 30 is used as a liquid crystal display element, display images are changed. The elongation of the helical pitch shifts the selective reflection wavelength of Bragg reflection to the long wavelength side,

According to the second embodiment-1, the liquid crystal layer 30L is the SPAN including a polymer network formed to have a constant helical pitch. Thus, the liquid crystal cell 30 presents a strong Bragg reflection at a specific selective reflection wavelength. The cholesteric phase that is the base of the SPAN has accomplishments of application of many liquid crystal elements, and also has a high reliability. The liquid crystal layer 30L is the SPAN including the achiral liquid crystal component, and hence the liquid crystal molecular orientation can be changed by the application of a small voltage. As described above, according to the second embodiment-1, a liquid crystal element can be obtained in which useful optical properties unique to the PSCT are shown, at the same time, a low drive voltage is achieved.

### Second Embodiment-2: A Liquid Crystal Cell Including a Liquid Crystal Layer Formed of the SPAN

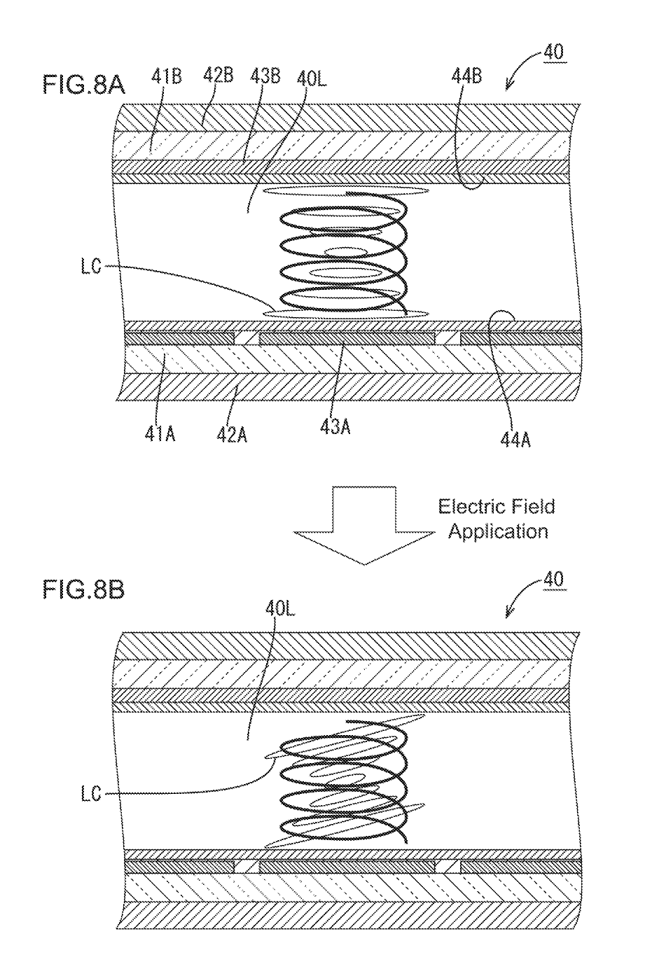

Referring to FIGS. 8A and 8B, a second embodiment-2 will be described. A liquid crystal cell 40 according to the second embodiment-2 has a liquid crystal layer formed of the SPAN prepared in the second embodiment and a unit that applies an electric field to this liquid crystal layer. The cell 40 is different from, the liquid crystal cell 30 according to the second embodiment-1 in that the electric field application unit imparts an electric field acting on the liquid crystal layer in the direction (in the vertical direction) almost vertical to substrates sandwiching the liquid crystal layer.

Liquid Crystal Cell 40

As illustrated in FIGS. 8A and 8B, in the second embodiment-2, a liquid crystal cell 40 (an example of a liquid crystal element) is described as an example, including a pair of substrates 41A and 41B, a liquid crystal layer 40L sandwiched between these two substrates, and polarizers 42A and 42B respectively attached to the substrates 41A and 41B in crossed Nicols arrangement. Note that similarly to the liquid crystal layer 30L according to the second embodiment-1, the liquid crystal layer 40L is formed of the SPAN prepared in the second embodiment, and includes positive nematic liquid crystal molecules LC having positive dielectric anisotropy as liquid crystal molecules.

Substrates 41A and 41B

In the liquid crystal cell 40 according to the second embodiment-2, in the substrates 41A and 41B, only a pixel electrode 43A is formed as an electrode on the pixel electrode substrate 41A, and formed with no common electrode. On the other hand, on the counter electrode substrate 41B, a counter electrode 43B is formed using a transparent conductive material. Thus, upon the application of a voltage across the pixel electrode 43A of the pixel electrode substrate 41A connected to an external power supply, for example, and the counter electrode 43B of the counter electrode substrate 41B, an electric field acting in the direction substantially perpendicular to the plate surface of the substrate (in the vertical direction) is applied to the liquid crystal layer 40L. Note that at the position in contact with the liquid crystal layer 40L on the inner surfaces (where the liquid crystal layer 40L is disposed) of the substrates 41A and 41B, alignment films 44A and 44B are formed. The alignment films 44A and 44B align the liquid crystal molecules LC in the liquid crystal layer 40L in homogeneous alignment with no electric field applied. Note that under the conditions in which the liquid crystal molecules LC in the liquid crystal layer 40L only have to be in homogeneous alignment, the alignment films 44A and 44B do not necessarily to be provided. Instead of the alignment films 44A and 44B, irregularities (alignment regulation projection) formed of minute line-shaped projection (bank-like structures) or slits (groove-like structures), for example, may be provided on the inner surfaces of the substrates 41A and 41B.

### Operation and Effect of the Second Embodiment-2

FIGS. 8A and 8B are images of a change in the molecular orientation of the liquid crystal molecules LC in the liquid crystal cell 40 according to the second embodiment-2. FIG. 8A is the image with application of no electric field, and FIG. 8B is the image with application of no electric field.

The liquid crystal layer 40L is formed of the SPAN. The liquid crystal molecules LC in the SPAN are in planar alignment with application of no electric field to present Bragg reflection.

Upon the application of a voltage across the pixel electrode 43A and the counter electrode 43B using the external power-supply, an electric field (the vertical electric field) substantially perpendicular to the substrates 41A and 41B is imparted to the liquid crystal layer 40L, and the molecular orientation of the liquid crystal molecules LC in the liquid crystal layer 40L is changed. As illustrated in FIGS. 8A and 8B, after the vertical electric field is imparted, the helix of the positive nematic liquid crystal molecules LC having a positive dielectric constant included in the liquid crystal layer 40L is inclined to the substrate surface, and the helical pitch in the direction perpendicular to the substrate is shortened. The optical transparency of the liquid crystal cell 40 is changed depending on such a corresponding change in birefringence. For example, in the case in which the liquid crystal cell 4 0 is used as a liquid crystal display element, display images on the liquid crystal display element are changed. The helical pitch in the direction perpendicular to the substrate is seemingly shortened, and hence the selective reflection wavelength of Bragg reflection can be shifted to the short wavelength side. Note that the application of an electric field until the liquid crystal molecules LC are in homeotropic alignment removes Bragg reflection.

As described above, also in the second embodiment-2, similarly to the liquid crystal cell 30 according to the second embodiment-1, a liquid crystal element is obtained in which useful optical properties unique to the PSCT are shown and a low drive voltage simultaneously is achieved.

### Second Embodiment-3: A Liquid Crystal Display Device Including a Liquid Crystal Layer Formed of the SPAN

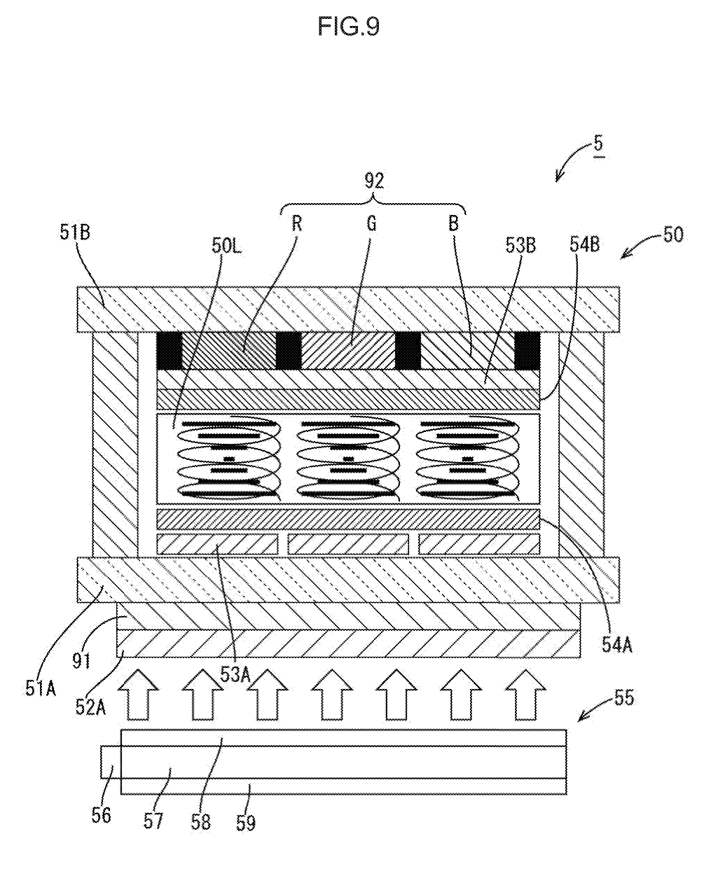

Referring to FIG. 9, a second embodiment-3 will be described. In the second embodiment-3, a monochrome photoirradiation quantum dot conversion liquid crystal display device 5 is described as an example to which useful properties unique to the SPAN is applied.

Liquid Crystal Display Device 5

A liquid crystal display device 5 according to the second embodiment-3 includes a panel-like liquid crystal cell 50 and a backlight unit 55 stacked on one of the plate surfaces of the liquid crystal cell 50. As described later, this backlight unit 55 applies monochromatic light toward the liquid crystal cell 50. The liquid crystal cell 50 has a polarization converting unit formed of a polarizer 52A and a retardation plate 91 and a wavelength converting unit formed of a wavelength conversion layer 92 as described later.

Backlight Unit 55

The backlight unit 55 that applies light toward the

liquid crystal cell 50 has a light source 56 composed of blue LEDs that emit monochromatic light, blue light having a peak wavelength of 450 nm, for example. The backlight unit 55 may be a direct type or may be an edge light type backlight unit. Here, the backlight unit 55 of the edge light type backlight unit is described as an example. The backlight unit 55 has a light source 56, a light guide plate 57, an optical sheet 58, and a reflective sheet 59.

Liquid Crystal Cell 50

As illustrated in FIG. 9, the liquid crystal cell 50 according to the second embodiment-3 includes a pair of substrates 51A and 51B, a liquid crystal layer 30L sandwiched between these two substrates, a polarizer 52A attached to the first substrate 51A, and the retardation plate 91 disposed between the substrates 51A and the polarizer 52A. The liquid crystal cell 50 is an example of a liquid crystal element that performs display using a change in the birefringence of the liquid crystal layer 30L.

Liquid Crystal Layer 50L

The liquid crystal layer 30L is formed of the SPAN prepared in the second embodiment. Note that liquid crystal molecules included in the liquid crystal layer 50L preferably have positive dielectric anisotropy. Here, an example is shown in the case in which positive liquid crystal molecules LC are used. The SPAN is prepared such that with the adjustment of the HTP or the loadings, for example, of the chiral compound added to the liquid crystal composite in the second embodiment, the helical pitch is provided, the helical pitch that exhibits almost the same selective reflection wavelength as the wavelength λ (near 450 nm) of blue light with no electric field applied. With this preparation, a high contrast ratio is exhibited in the case in which a backlight that emits collimated light is used. From, the viewpoint of the contrast ratio, in the case in which the backlight emits diffused light, preferably, a high reflectance is maintained in a range including the blue light wave range to the long wavelength side as the wavelength of blue light is set at the short wavelength end. In this case, a chiral polymerizable monomer may be used as a part of the polymerizable monomer. A chiral polymerizable monomer is used as a polymerizable monomer, and hence a high reflectance is maintained in a desired wavelength.

Substrates 51A and 51B

The substrates 51A and 51B each include a transparent substrate. At least two films are stacked on the transparent substrate by known photolithography, for example. In the stacked structure, at least two electrodes connected to the external power supply, for example, composed of a conductive film are formed. Here, the formed substrates 51A and 51B are described as an example in which the liquid crystal layer 30L is applied with an electric field acting in the direction substantially perpendicular to (in the vertical direction) the plate surfaces of the substrates 51A and 51B.

In the substrates, the first substrate stacked with the backlight unit 55 is the pixel electrode substrate 51A. On the substrate 51A, in addition to the switching element, a pixel electrode 53A is provided. The pixel electrode 53A is formed of a transparent conductive material connected to a switching element. In the substrates, the second substrate is the counter substrate 51B. The counter substrate 51B is formed with a wavelength conversion layer 92. The wavelength conversion layer 92 is formed with a red converting unit R, a green converting unit G, and a blue diffusion unit B in a predetermined array. The red converting unit R is formed of a resin having red quantum dots dispersed, the red quantum dots converting blue light into red light, for example. The green converting unit G is formed of a resin having green quantum dots dispersed, the green quantum dots similarly converting blue light into green light. The blue diffusion unit B is formed of a resin diffusing blue light. In FIG. 9, for illustration, only one each of the red converting unit R, the green converting unit G, and the blue diffusion unit B are depicted. On the counter substrate 51B, at least two red converting units R, at least two green converting units G, and at least two blue diffusion units B are formed. These units R, G, and B correspond to the pixel electrode 53A. On the underside of the wavelength conversion layer 92, a counter electrode 53B formed of a transparent conductive material is provided. On the inner surfaces of the substrates 51A and 51B, alignment films 54A and 54B are respectively formed. Here, the alignment films 54A and 54B homogeneously align the liquid crystal molecules LC in the liquid crystal layer 30L with application of no electric field. Note that the alignment films 54A and 54B are not necessarily provided when the liquid crystal molecules LC are in homogeneous alignment with application of no electric field. For example, a configuration may be provided in which a member, for example, is provided on the substrates 51A and 51B at the position in contact with the liquid crystal layer 30L, and the member induces homogeneous alignment of the liquid crystal molecules LC.

The retardation plate 91 provided between the pixel electrode substrate 51A and the polarizer 52A converts light that is linearly polarized by the polarizer 52A into circularly polarized light. The retardation plate 91 has its birefringence such that the phase difference between the phase of the wavelength of abnormal light and the phase of the wavelength of normal light is λ/4 to the wavelength λ of blue light applied from, the backlight unit 55.

### Operation and Effect of the Second Embodiment-3

The liquid crystal molecules LC in the liquid crystal layer 30L formed of the SPAN area in planar alignment with no electric field applied. As described above, the molecules LC have a helical pitch presenting almost the same selective reflection wavelength as the wavelength λ of blue light. Thus, with no electric field applied, the blue light emitted from the backlight unit 55, converted into circularly polarized light by the retardation plate 91, and entered into the liquid crystal layer 30L is reflected off by Bragg reflection of the liquid crystal layer 30L at a considerably high probability.

Upon the application of a voltage across the pixel electrode 53A and the counter electrode 53B using the external power supply, a vertical electric field is imparted to the liquid crystal layer 30L. However, since the positive nematic liquid crystal molecules LC having a positive dielectric constant are used for the liquid crystal layer 30L, the liquid crystal molecules LC are aligned such that the molecules LC rise in the direction perpendicular to the substrate as observed in the second embodiment-2, and the helix is inclined to the substrate surface. Thus, the helical pitch in the direction perpendicular to the substrate is shortened, and the selective reflection wavelength of Bragg reflection is shifted to the short wavelength side. Thus, blue light is hardly reflected off, and transmitted through the liquid crystal layer 30L, and reached to the wavelength conversion layer 92. The light entered to the red converting unit R is wavelength-converted into red light, and the light entered to the green converting unit G is wavelength-converted into green light. The light entered to the blue diffusion unit B is diffused, and emitted from the counter substrate 51B side surface (the image display surface) of the liquid crystal cell 50. The quantity of blue light reached to the wavelength conversion layer 92 can be adjusted by controlling the voltage applied to the pixel electrode 53A and the counter electrode 53B. After the electric field is applied until the liquid crystal molecules LC are in homeotropic alignment, the selective reflection wavelength is eliminated. Note that in the case in which the pixel electrode and the common electrode are provided on the pixel electrode substrate and a transverse electric field is applied to the liquid crystal layer 50L, electric field application elongates the helical pitch, and the selective reflection wavelength is shifted the long wavelength side.

As described in the second embodiment-3, a liquid crystal display device is provided, including a lighting unit that applies monochromatic light and a liquid crystal cell (the liquid crystal display panel, an example of a liquid crystal element). The liquid crystal cell includes a pair of the substrate, an electrode provided on one or both of the pair of substrates, a liquid crystal layer sandwiched between the pair of substrates, a circular polarization unit configured to convert the monochromatic light into circularly polarized light, and a wavelength conversion unit configured to the wavelength of the circularly polarized light using a quantum dot. For a device in which an electric field is applied to the liquid crystal layer through the electrode to control the alignment of the liquid crystal molecules LC in the liquid crystal layer and hence the birefringence of the liquid crystal layer is changed to display an image, the liquid crystal layer is formed of a polymer/liquid crystal composite material according to the technology described herein that can exhibit the liquid crystal molecular orientation similar to the cholesteric phase. The selective reflection wavelength of the cholesteric phase with application of no electric field is almost the same the wavelength of the monochromatic light, which can be achieved.

In the liquid crystal display device 5 according to the second embodiment-3 as described above, from the viewpoint of improving the display contrast, the light emitted from the backlight unit 55 is monochromatic light in a narrow wavelength range. A typical cholesteric phase or PSCT having Bragg reflection in the short wavelength range, such as blue light, has a short helical pitch, and a large twisting force works on the liquid crystal molecules included in these chiral liquid crystal components. Thus, the voltage needed to release the force and change the molecular orientation of liquid crystal molecules, i.e., the drive voltage is inevitably increased. Even though the liquid crystal layer 30L formed of the SPAN according to the technology described herein has Bragg reflection in the short wavelength range the same as blue light, for example, its drive voltage is low, and hence light transmittance can be controlled highly accurately with power saving. As described above, the technology described herein is considerably preferably applicable to quantum dot display devices using monochromatic light having short wavelengths, such as blue light, specifically.

The liquid crystal display device 5 according to the second embodiment-3 can be used for devices including television receiver devices, and display for personal computers, tablet terminals, mobile telephones, monitors, and any other device.

### Second Embodiment-4: A Liquid Crystal Display Device Including a Liquid Crystal Layer Formed of the SPAN

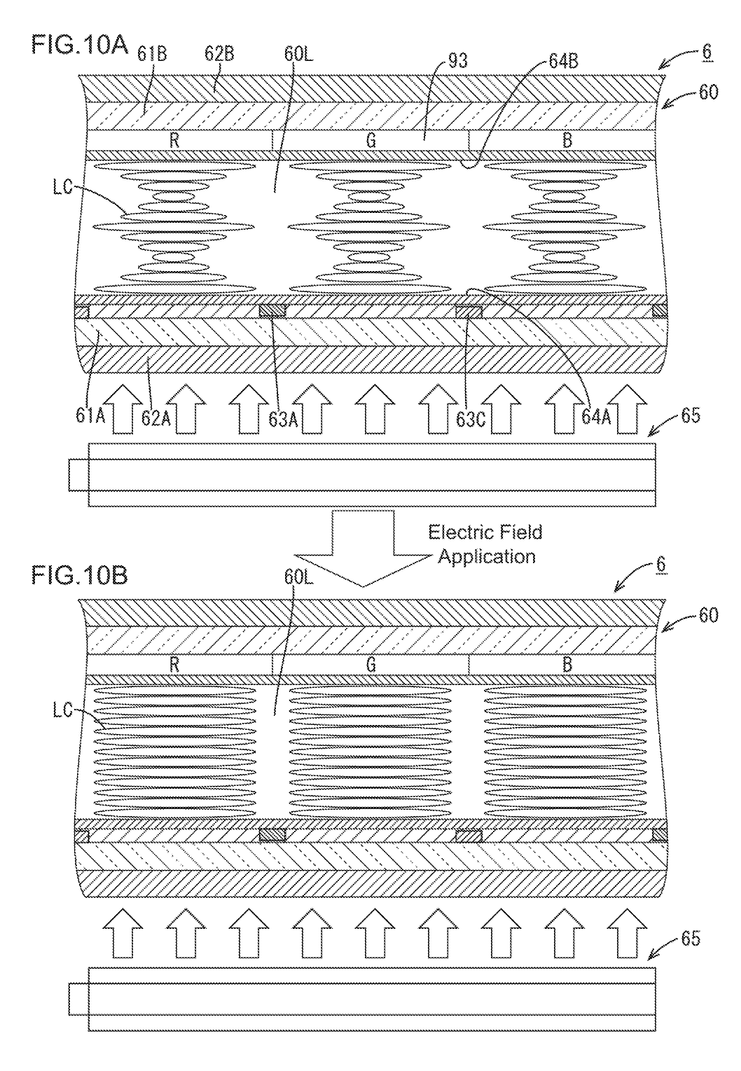

Referring to FIGS. 10A and 10B, a second embodiment-4will be described. In the second embodiment-4, as an example to which the properties unique to the SPAN are specifically effectively applied, a liquid crystal display device 6 is described as an example in which an electric field is imparted to a liquid crystal layer showing optical isotropy in a specific direction to exhibit optical anisotropy, and the display state is changed.

Liquid Crystal Display Device 6

The liquid crystal display device 6 according to the second embodiment-4 includes a panel-like liquid crystal cell 60 and a backlight unit 65 stacked on one of the plate surfaces of the liquid crystal cell 60. The backlight unit 65 according to the embodiment can be a typical backlight unit having a known schematic configuration, and the description is omitted.

Liquid Crystal Cell 60

The liquid crystal cell 60 according to the second embodiment-4 can have a known schematic configuration, including a pair of substrates 61A and 61B through which am electric field acting substantially in parallel with the substrate surface (in the lateral direction) is applied to a liquid crystal layer 60L sandwiched between the substrates 61A and 61B.

Liquid Crystal Layer 60L

The liquid crystal layer 60L formed of the SPAN includes, as liquid crystal molecules, nematic liquid crystal molecules LC having positive dielectric anisotropy. In the second embodiment-4, preparation is made such that the HTP or the loadings, for example, of the chiral compound added to the liquid crystal composite is adjusted and hence the SPAN has a helical pitch smaller than the visible light wavelength with no electric field applied.

Substrates 61A and 61B

The substrates 61A and 61B basically have configurations similar to the substrates 11A and 11B described in the first embodiment-1, except that the counter substrate 61B is provided with a color filter layer 93 formed of R, G, B filters and alignment films 64A and 64B are respectively provided on the substrates 61A and 61B on the liquid crystal layer 60L side. The pixel electrode substrate 61A is formed with a pixel electrode 63A and a common electrode 63C. The alignment films 64A and 64B cause the liquid crystal molecules LC in the liquid crystal layer 60L to be in homogeneous alignment with application of no electric field. Note that the alignment films 64A and 64B are not necessarily provided when the liquid crystal molecules LC are set to form homogeneous alignment with application of no electric field. For example, on the inner surfaces of the substrates 61A and 61B, a structure that induces homogeneous alignment is induced may be formed. On the outer surfaces (the surfaces opposite to the surfaces on which the liquid crystal layer 30L is disposed) of the substrates 61A and 61B, polarizers 62A and 62B in crossed Nicols arrangement are respectively attached.

### Operation and Effect of the Second Embodiment-4

As described in the second embodiment-4, the liquid crystal display device includes a liquid crystal cell (a liquid crystal display panel, an example of a liquid crystal element). The liquid crystal cell includes a pair of substrates, an electrode provided on one or both of the pair of substrates, and a liquid crystal layer sandwiched between the pair of substrates. For a device in which an electric field is applied to the liquid crystal layer through the electrode to control the alignment of the liquid crystal molecules in the liquid crystal layer and hence the birefringence of the liquid crystal layer is changed to display an image, the liquid crystal layer is formed of a polymer/liquid crystal composite material according to the technology described herein that can exhibit the liquid crystal molecular orientation similar to the liquid crystal molecules in a cholesteric phase. The helical pitch in the cholesteric phase with application of no electric field is smaller than the visible light wavelength, the molecules are in planar alignment with application of no electric field, and the molecules are optically isotropic to the substrate surface nearly in parallel with the surfaces of the pair of substrates. The molecules exhibit optical anisotropy on the surfaces in parallel with the substrates with the application of an electric field.

As illustrated in FIG. 10A, in the liquid crystal cell 60, the liquid crystal molecules LC oriented to have the selective reflection wavelength less than the visible light wavelength with no electric field applied are in planar alignment. On the surfaces in parallel with the substrates (in a planer view of the liquid crystal layer 60L from the normal direction the substrate), the liquid crystal molecules LC are randomly aligned on to show optical isotropy. As illustrated in FIG. 10B, transverse electric field application to the liquid crystal layer 60L in this state orients the liquid crystal molecules LC in one direction on the surfaces in parallel with the substrates to exhibit optical anisotropy. In the exhibition of optical anisotropy, the helical structure of the liquid crystal molecules LC is destructured to change the molecular orientation. However, in the SPAN where a low drive voltage is achieved, the molecular orientation of the liquid crystal molecules LC can be changed at a voltage lower than a voltage used in typical cholesteric phase or PSCT. As described above, the technology described herein is specifically preferably applicable to a liquid crystal display device in which the orientation of the liquid crystal molecules LC in the liquid crystal layer 60L that have shown optical isotropy is changed to exhibit optical anisotropy for changing display states on the surfaces in parallel with the substrates.

The liquid crystal display device 6 according to the second embodiment-4 can be used for devices including television receiver devices, and display for personal computers, tablet terminals, mobile telephones, monitors, and any other device.

### Second Embodiment-5: A Light Modulation Element Including a Liquid Crystal Layer Formed of the SPAN

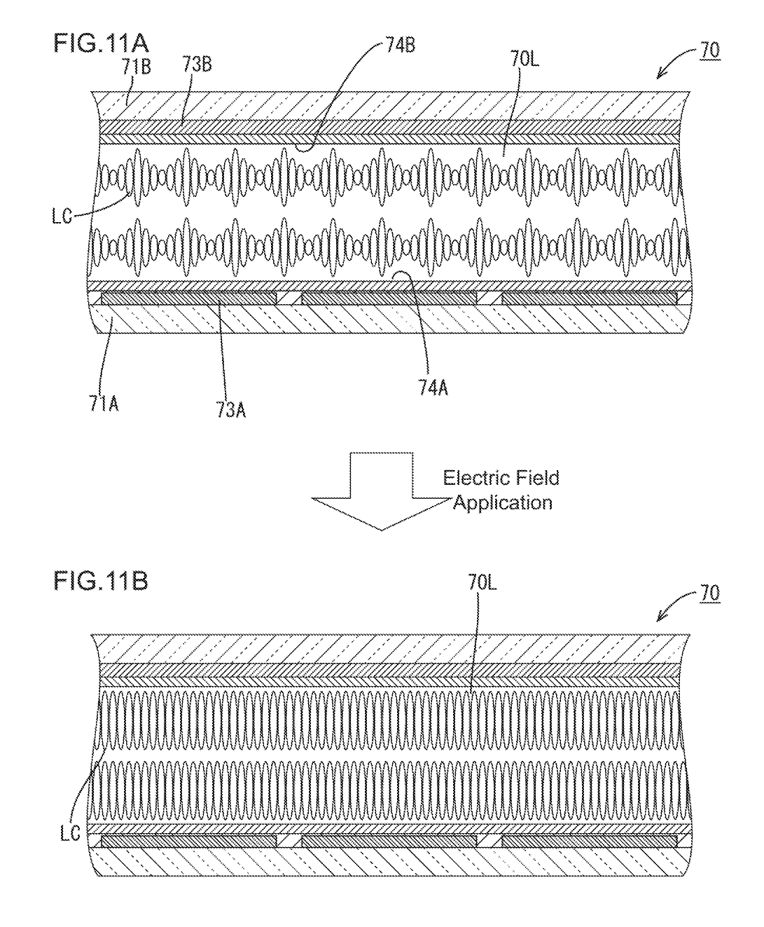

Referring to FIGS. 11A and 11B, a second embodiment-5 will be described. In the second embodiment-5, a light modulation element 70 having a liquid crystal layer formed of the SPAN prepared in the second embodiment and a unit that applies an electric field to this liquid crystal layer is described as an example.

Light Modulation Element 70

The light modulation element according to the technology described herein can be a known schematic configuration. As illustrated in FIGS. 11A and 11B, in the second embodiment-5, the light modulation element 70 including a pair of substrates 71A and 71B and a liquid crystal layer 70L sandwiched between these two substrates is described as an example. The light modulation element 70 is an example of a liquid crystal element using a change in the refractive index of the liquid crystal layer 70L.

Liquid Crystal Layer 70L

The liquid crystal layer 70L is formed of the SPAN

prepared in the second embodiment. Note that the liquid crystal molecules Included in LC included in the liquid crystal layer 70L is preferably includes positive dielectric anisotropy. In the second embodiment-3, an example is shown in the case in which the liquid crystal molecules included in the liquid crystal layer 70L are positive nematic liquid crystal molecules LC.

Substrate 71A and 71B

In the light modulation element 70 according to the second embodiment-5, in the substrates 71A and 71B, the pixel electrode substrate 71A is formed only with a pixel electrode 73A as an electrode, and formed with no common electrode. On the other hand, the counter electrode substrate 71B is formed a counter electrode 73B using a transparent conductive material. Thus, upon the application of a voltage across the pixel electrode 73A of the pixel electrode substrate 71A connected to an external power supply, for example, and the counter electrode 73B of the counter electrode substrate 71B, an electric field acting in the direction substantially perpendicular to the plate surface of the substrate (in the vertical direction) is applied to the liquid crystal layer 70L. Note that at the positions in contact with the liquid crystal layer 70L on the inner surfaces (where the liquid crystal layer 70L is disposed) of the substrates 71A and 71B, alignment films 74A and 74B are formed. The alignment films 74A and 74B align the liquid crystal molecules LC in the liquid crystal layer 70L in the direction perpendicular to the substrate surfaces of the substrates 71A and 71B with no electric field applied. With no electric field applied, the liquid crystal molecules LC are in focal conic alignment. Alternatively, the molecules LC may be in random alignment with no electric field applied.

### Operation and Effect of the Second Embodiment-5

The liquid crystal layer 70L is formed of the SPAN. As illustrated in FIG. 11A, the liquid crystal molecules LC are in focal conic alignment in which the helical axis is nearly in parallel with the substrate surfaces with application of no electric field. Thus, light entered from the substrate 71B is scattered at the liquid crystal layer 70L.

Upon the application of a voltage across the pixel electrode 73A and the counter electrode 73B using the external power supply, an electric field acting on the liquid crystal layer 70L in the vertical direction is formed as illustrated in FIG. 11B. Suitable for the intensity of this electric field, the positive liquid crystal molecules LC in the liquid crystal layer 70L are changed to have homeotropic alignment having the helical axis almost vertical to the substrates. Thus, light can be transmitted, and the light modulation element 70 is transparent.

As described above, in the light modulation element 70 according to the second, embodiment-3, the liquid crystal layer 70L is formed of the SPAN. Thus, display can be changed with no polarizer, high luminance is achieved, as well as energy saving design is enabled due to a low drive voltage. Therefore, the light modulation element 70 is suitable for digital papers, electronic electrons books, or interior materials, for example.

### Other Embodiments

The technology described herein is not limited to the embodiments described above and with reference to the drawings. The following embodiments may be included in the technical scope.

(1) In the first embodiment, the polymerization of the polymerizable monomer may be started with an isotropic phase presented in the liquid crystal composite to form a polymer network. However, in the case of the isotropic phase, the temperature is controlled such that the phase is an isotropic phase before polymerization and a blue phase is exhibited as polymerization is advanced. With this configuration, the NCLC can be first obtained. Subsequently, the chiral compound included in the liquid crystal component is racemized to form the liquid crystal component into an achiral liquid crystal component. Thus, the polymer/liquid crystal composite material that can exhibit the BPTN can be obtained.

(2) The liquid crystal element using a change in the refractive index of the liquid crystal layer formed of the BPTN is not limited to the liquid crystal lens described in the first embodiment-2. For example, the element is also applicable to a waveguide, for example.

(3) In the second embodiment-4, the transmissive liquid crystal display device 6 is described. However, the liquid crystal display device 6 can also be a reflective liquid crystal display device. In the case of a reflective liquid crystal display device, the liquid crystal display device further includes a reflector that is disposed on the back surface side of the liquid crystal cell 60 and reflects off natural light toward the liquid crystal cell 60. On the liquid crystal cell 60, a polarizer and a retardation plate, for example, not shown, are stacked.

1. A liquid crystal composite comprising:
liquid crystal molecules showing liquid crystal properties;
a polymerizable monomer polymerized by an external stimulus, the polymerizable monomer having substantially no optical activity; and
a chiral compound that is racemized by an external stimulus, the chiral compound having an optical activity.

2. The liquid crystal composite according to claim 1, wherein the chiral compound is a photoracemized binaphthyl derivative.

3. The liquid crystal composite according to claim 2, wherein the chiral compound is a photoracemized binaphthyl compound expressed by chemical formula (1) 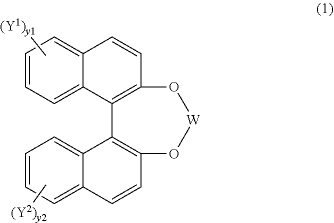
where, W is a bivalent alkylene group having one to four C atoms, the bivalent alkylene group may be substituted by X,
X, Y¹, and Y² are independent from each other, X, Y¹, and Y₂ are F, Cl, Br, I, CN, SCN, SF₅, straight-chain or branched alkyl having one to 25 C atoms, cycloalkyl or aryl having up to 20 C atoms, or mesogen M, y1 and y2 are independent from each other, and y1 and y2 are 0, 1, 2, 3, or 4;
the straight-chain or branched alkyl having one to 25 C atoms may be monosubstituted or multisubstituted by F, Cl, Br, I, or CN, one or two or more of non-neighboring CH₂ groups may be substituted by —O—, —S—, —NH—, NR⁰—, —CO—, —COO—, —OCO—, —OCOO—, —S—CO—, —CO—S—, —CH═CH—, or —C≡C— such that an O and/or S atom is not directly bonded to each other and independent from each other, and R⁰ is H or alkyl having one to four C atoms;
the cycloalkyl or the aryl having up to 20 C atoms may be monosubstituted or multisubstituted by optionally halogen, preferably F, or a polymerizable group;
the mesogen M is expressed by —Z¹—A¹-(Z²-A²)m-R or alternatively R¹ or A³;
Z¹ and Z² are independent from each other, Z¹ and Z² are a single bond, —O—, —S—, —CO—, —COO—, —OCO—, —O—COO—, —CO—NR⁰—, —NR⁰—CO—, —O—CH₂—, —CH₂—O—, —S—CH₂—, —CH₂—S—, —CF₂—O—, —O—CF₂—, —CF₂—S—, —S—CF₂—, —CH₂—CH₂—, —CH₂—CH₂—, —CH₂—CH₂—, —CF₂—CF₂—, —CH═N—, —N═CH—, —N═N—, —CH═CH—, —CF═CH—, —CH═CF—, —CF═CF—, —C═C—, or combination of two groups where two of O and/or S and/or N atoms are not directly bonded to each other, and are preferably a single bond, —COO—, —OCO—, —CF₂—O—, —O—CF₂—, —CH═CH—COO—, or —OCO—CH═CH—;
A¹, A², and A³ are independent from each other, A¹, A², and A³ are 1,4-phenylene where one or two non-neighboring CH groups may be substituted by N, 1,4-cyclohexylene where one or two non-neighboring CH₂ groups may be substituted by O and/or S, 1,3-dioxolane-4,5-diyl, 1,4-cyclohexenylene, 1,4-bicyclo[2.2.2]octylene, piperidine-1,4-diyl, naphthalene-2,6-diyl, decahydronaphthalene-2,6-diyl, o r 1,2,3,4-tetrahydronaphthalene-2,6-diyl, each of the groups may be monosubstituted or multisubstituted by L, and A¹ is a single bond;
L is a halogen atom, preferably F, CN, NO₂, or alkyl, alkoxy, alkylcarbonyl, alkoxycarbonyl, or alkoxycarbonyloxy having one to seven C atoms, and one or two or more of H atoms may be substituted by F or Cl;
m is independently 0, 1, 2, or 3; and
R and R¹ are independent from each other, R and R¹ are H, F, Cl, Br, I, CN, SCN, SF₅, or straight-chain alkyl or branched alkyl having one or two to 25 C atoms, R and R¹ may be optionally monosubstituted or multisubstituted by F, Cl, Br, I, or CN, one or two or more of non-neighboring CH₂ groups may be substituted by —O—, —S—, —NH—, —NR⁰—, —CO—, —COO—, —OCO—, —O—COO—, —S—CO—, —CO—S—, —CH═CH—, or —C≡C—, and two of O and/or S atom are not directly bonded to each other.

4. A polymer/liquid crystal composite material comprising:
an achiral liquid crystal component; and
a polymer network, wherein
the achiral liquid crystal component includes liquid crystal molecules showing liquid crystal properties, and a racemate of chiral compound, and
the polymer network molecularly orients the liquid crystal molecules similarly to liquid crystal molecules in a predetermined chiral liquid crystal phase.

5. The polymer/liquid crystal composite material according to claim 4, wherein the racemate is generated by racemization of a chiral compound included in the liquid crystal component due to an external stimulus.

6. The polymer/liquid crystal composite material according to claim 4, wherein the racemate is a racemate of a photoracemized binaphthyl compound expressed by chemical formula (1) 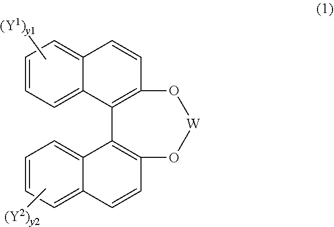
where, W is a bivalent alkylene group having one to four C atoms, W may be substituted by X, X, Y¹, and Y² are independent from each other, X, Y¹, and Y² are F, Cl, Br, I, CN, SCN, SF₅, straight-chain or branched alkyl having one to 25 C atoms, cycloalkyl or aryl having up to 20 C atoms, or mesogen M, y1 and y2 are independent from each other, y1 and y2 are 0, 1, 2, 3, or 4, the straight-chain or branched alkyl having one to 25 C atoms may be monosubstituted or multisubstituted by F, Cl, Br, I, or CN, one or two or more of non-neighboring CH₂ groups may be substituted by —O—, —S—, —NH—, NR⁰—, —CO—, —COO—, —OCO—, —OCOO—, —S—CO—, —CO—S—, —CH═CH—, or —C≡C— such that an O and/or S atom is not directly bonded to each other and independent from each other, and R⁰ is H or alkyl having one to four C atoms;
the cycloalkyl or the aryl having up to 20 C atoms may be monosubstituted or multisubstituted by optionally halogen, preferably F, or polymerizable group;
the mesogen M is expressed by —Z¹-A¹-(Z²-A²) m-R or alternatively by R¹ or A³;
Z¹ and Z² are independent from each other, Z¹ and Z² are a single bond, —O—, —S—, —CO—, —COO—, —OCO—, —O—COO—, —CO—NR⁰—, —NR⁰—CO—, —O—CH₂—, —CH₂—O—, —S—CH₂—, —CH₂—S—, —CF₂—O—, —O—CF₂—, —CF₂—S—, —S—CF₂—, —CH₂—CH₂—, —CF₂—CH₂—, —CH₂—CF₂—, —CF₂—CF₂—, —CH═N—, —N═CH—, —N═N—, —CH═CH—, —CF═CH—, —CH═CF—, —CF═CF—, —C≡C—, or combination of two groups where two of O and/or S and/or N atoms are not directly bonded to each other, and Z¹ and Z² are preferably a single bond, —COO—, —OCO—, —CF₂—O—, —O—CF₂—, —CH═CH—COO—, or —OCO—CH═CH—;
A¹, A², and A³ are independent from each other, A¹, A², and A³ are 1,4-phenylene where one or two non-neighboring CH groups may be substituted by N, 1,4-cyclohexylene where one or two non-neighboring CH₂ groups may be substituted by O and/or S, 1,3-dioxolane-4,5-diyl, 1,4-cyclohexenylene, 1,4-bicyclo[2.2.2]octylene, piperidine-1,4-diyl, naphthalene-2,6-diyl, decahydronaphthalene-2,6-diyl, or 1,2,3,4-tetrahydronaphthalene-2,6-diyl, each of the groups may be monosubstituted or multisubstituted by L, and A¹ is a single bond;
L is halogen atom, preferably F, CN, NO₂, or alkyl, alkoxy, alkylcarbonyl, alkoxycarbonyl, or alkoxycarbonyloxy having one to seven C atoms, and one or two or more of H atoms may be substituted by F or Cl;
m is independently 0, 1, 2, or 3; and
R and R¹ are independent from each other, R and R¹ are H, F, Cl, Br, I, CN, SCN, SF₅, or straight-chain alkyl or branched alkyl having one or two to 25 C atoms, R and R¹ may be optionally monosubstituted or multisubstituted by F, Cl, Br, I, or CN, one or two or more of non-neighboring CH₂ groups may be substituted by —O—, —S—, —NH—, —NR⁰—, —CO—, —COO—, —OCO—, —O—COO—, —S—CO—, —CO—S—, —CH═CH—, or —C≡C—, and two of O and/or S atom are not directly bonded to each other.

7. A polymer/liquid crystal composite material comprising:
an achiral liquid crystal component; and
a polymer network,
wherein
the polymer/liquid crystal composite material is prepared by imparting an external stimulus is imparted to the liquid crystal composite according to claim 1,
the achiral liquid crystal component includes the liquid crystal molecules, and a racemate generated by racemization of the chiral compound with an external stimulus, and
the polymer network is formed by imparting an external stimulus to the liquid crystal composite to polymerize the polymerizable monomer with a predetermined chiral liquid crystal phase presented in the liquid crystal composite.

8. The polymer/liquid crystal composite material according to claim 4, wherein the predetermined chiral liquid crystal phase is a cholesteric phase.

9. The polymer/liquid crystal composite material according to claim 4, wherein the predetermined chiral liquid crystal phase is a blue phase.

10. A method of producing a polymer/liquid crystal composite material comprising:
preparing a liquid crystal composite including liquid crystal molecules showing liquid crystal properties, a polymerizable monomer having substantially no optical activity and polymerized by an external stimulus, and a chiral compound having an optical activity and racemized by an external stimulus;
forming a polymer network by imparting an external stimulus to polymerize the polymerizable monomer with a predetermined chiral liquid crystal phase presented in the liquid crystal composite; and
racemizing to impart an external stimulus such that racemization of the chiral compound is completed after completion of polymerization of the polymerizable monomer, wherein
the polymer network molecularly orients the liquid crystal molecules included in a liquid crystal component from which the polymer network is removed from the liquid crystal composite similarly to liquid crystal molecules in the predetermined chiral liquid crystal phase, and
the external stimulus that induces polymerization of the polymerizable monomer is selected such that under conditions in which the external stimulus is imparted, polymerization velocity of the polymerizable monomer is faster than racemization velocity of the chiral compound, and chirality of the liquid crystal component is maintained at nearly constant before start of polymerization of the polymerizable monomer until formation of the polymer network is completed.

11. A liquid crystal element comprising:
a pair of substrates;
an electrode provided on one or both of the pair of substrates; and
a liquid crystal layer sandwiched between the pair of substrates, the liquid crystal layer being formed of the polymer/liquid crystal composite material according to claim 3, wherein
an electric field is applied to the liquid crystal layer through the electrode to control alignment of the liquid crystal molecules, and optical properties of the liquid crystal element are changed.

12. A liquid crystal display device comprising the liquid crystal element according to claim 10.
